(19) United States
(12) Patent Application Publication
(10) Pub. No.: US 2016/0277276 A1
(43) Pub. Date: Sep. 22, 2016

(54) SYSTEM FOR ANALYZING PATIENT OUT-OF-NETWORK UTILIZATION AND IMPROVING RETENTION

(71) Applicant: Aetna Inc., Hartford, CT (US)

(72) Inventors: Royal Tuthill, Sea Cliff, NY (US); Kristen Coletto, New York, NY (US); Chad Allen, San Francisco, CA (US)

(21) Appl. No.: 15/169,043

(22) Filed: May 31, 2016

Related U.S. Application Data
(63) Continuation of application No. 15/141,053, filed on Apr. 28, 2016.
Application No. 15/141,053 is a continuation of application No. 15/087,333, filed on Mar. 31, 2016.
Application No. 15/087,333 is a continuation-in-part of application No. 14/490,111, filed on Sep. 18, 2014.

(51) Int. Cl. H04L 12/26; H04L 29/08

(52) U.S. Cl. CPC H04L 43/0876; H04L 43/062; H04L 67/10

(57) ABSTRACT

A patient out-of-network utilization analysis and reporting system includes: an out-of-network utilization analysis server, configured to access one or more databases to obtain healthcare claims information, to generate out-of-network utilization analysis information corresponding to identification of potential sources of patient out-of-network utilization based on the obtained healthcare claims information, and to the send out-of-network utilization analysis information to a client computing device, wherein the healthcare claims information includes procedure-related information and/or physician attribution information; and the client computing device, configured to receive out-of-network utilization analysis information via a network from a server and to display the out-of-network utilization analysis information to a user of the client computing device.

### CROSS-REFERENCE TO RELATED APPLICATIONS

This patent application is a continuation of copending U.S. patent application Ser. No. 15/141,053, filed Apr. 28, 2016, which is a continuation of copending U.S. application Ser. No. 15/087,333, filed Mar. 31, 2016, which is a continuation-in-part of copending U.S. patent application Ser. No. 14/490,111, filed Sep. 18, 2014. All of the foregoing applications are incorporated by reference herein in their entireties.

### BACKGROUND

For healthcare provider organizations—such as Accountable Care Organizations (ACOs) which include a group of doctors and/or hospitals that assume responsibility for quality and cost of health care for a defined set of patients, as well as other providers such as non-ACO hospital/physician groups, large employers, and insurance providers—patient out-of-network utilization (where patients go outside of the provider organization's network for healthcare services) is a significant concern. On average, provider organizations experience 40% to 80% patient out-of-network utilization rates, which results in significant lost revenue, increased costs for the patient, potentially decreased quality of care for the patient, and gaps in patient health data.

A conventional method of attempting to identify out-of-network utilization and improve retention is to look at macro trends in the patient population by obtaining de-identified claims data from payors. However, this method provides only a very general indication regarding the occurrence of out-of-network utilization, and is unable to provide specific information at the patient and claim level.

### SUMMARY

Embodiments of the invention provide systems and methods by which a provider organization (e.g., ACO, non-ACO groups, employers, healthcare insurance and plan providers, etc.) is able to better understand patient out-of-network utilization and leverage that understanding to increase patient retention. In an exemplary embodiment, the invention provides a healthcare analysis system, accessible by remote computing devices to provide an interactive interface to allow different types of users (e.g., provider administrators, hospital administrators, physicians, etc.) to determine specific details regarding patient out-of-network utilization in a manner that will help them to, for example: quantify patient out-of-network utilization/retention, determine where out-of-network utilization is occurring (e.g., by service line, physician, health plan, etc.), determine opportunities to improve patient retention, identify where leaked patients are going for out-of-network services, improve physician awareness, and obtain detailed patient and claim level information.

### BRIEF DESCRIPTION OF THE SEVERAL VIEWS OF THE DRAWINGS

While the appended claims set forth the features of the present invention with particularity, the invention, together with its objects and advantages, may be best understood from the following detailed description taken in conjunction with the accompanying drawings of which:

FIG. 1 is a block diagram illustrating an exemplary environment for a networked system in an embodiment.

FIG. 2 is a block diagram illustrating elements of FIG. 1 in greater detail.

FIGS. 3 and 4 are flowcharts illustrating exemplary processes for patient out-of-network utilization analysis in exemplary embodiments.

FIGS. 5-11 are exemplary screens illustrating a user interface for reporting patient out-of-network utilization-related information.

FIG. 12 is an example of a graphical user interface (GUI) screen providing information regarding total payment amounts for in-network and out-of-network services (including offered and non-offered out-of-network services).

FIG. 13 is an example of a GUI screen providing information regarding payment percentages for in-network and out-of-network services (including offered and non-offered out-of-network services).

FIG. 14 is an example of a GUI screen providing information regarding payment amounts per member per month (PMPM) for in-network and out-of-network services (including offered and non-offered out-of-network services).

FIG. 15 is an example of a GUI screen providing information regarding payment percentages per member per month (PMPM) for in-network and out-of-network services (including offered and non-offered out-of-network services).

FIG. 16 is an example of a GUI screen providing information regarding a total number of visits per 1000 members for in-network and out-of-network services (including offered and non-offered out-of-network services).

FIG. 17 is an example of a GUI screen providing information regarding percentages of visits per 1000 members for in-network and out-of-network services (including offered and non-offered out-of-network services).

FIGS. 18A-18B are examples of GUI screens providing information regarding professional services lines corresponding to out-of-network utilization (including offered and non-offered out-of-network services).

FIG. 19 is an example of a GUI screen providing information regarding professional services lines corresponding to out-of-network utilization for offered services.

FIG. 20 is an example of a GUI screen providing information regarding professional services lines corresponding to out-of-network utilization for oftfered services.

FIG. 21 is an example of a GUI screen providing information regarding procedure groups from a particular professional service line.

FIG. 22 is an example of a GUI screen providing information regarding procedures from a particular procedure group.

FIG. 23 is an example of a GUI screen providing information regarding claims for a particular procedure.

FIGS. 24A-24B are examples of GUI screens providing information regarding out-of-network utilization corresponding to attributed practices.

FIG. 25 is an example of a GUI screen providing information regarding providers associated with a particular attributed practice.

FIG. 26 is an example of a GUI screen providing information regarding claims associated with a particular provider.

FIG. 27 is an example of a GUI screen providing information regarding claims associated with a particular provider.

### DETAILED DESCRIPTION

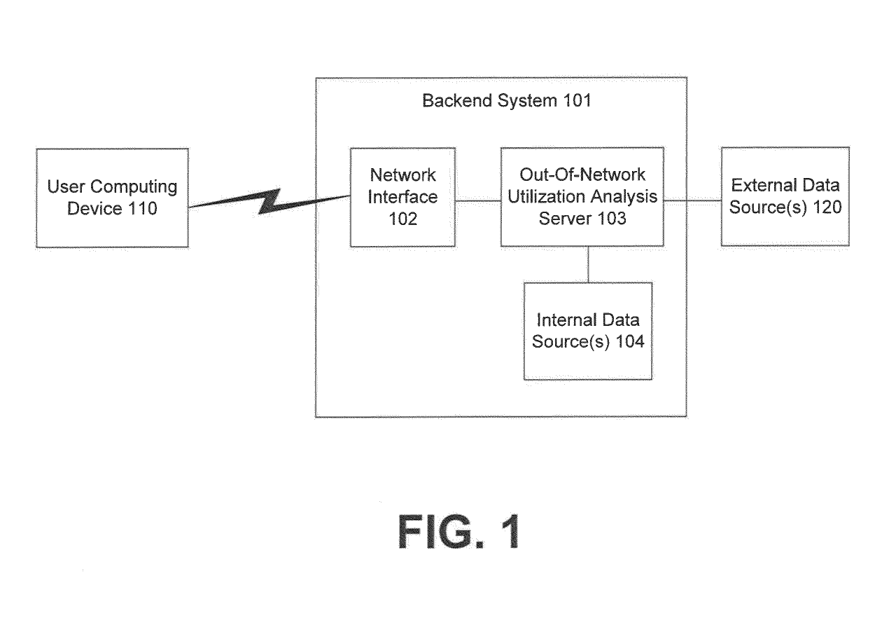

FIG. 1 is a block diagram illustrating an exemplary environment suitable for implementing embodiments of the invention. The environment includes a backend system 101 having a network interface 102 (e.g., a web server) through which remote computing devices such as user computing device 110 (e.g., a personal computer, laptop, tablet, smartphone, etc.) can connect to components of the backend system 101. The backend system 101 further includes an out-of-network utilization analysis server 103 (e.g., a specifically-configured application server) for providing out-of-network utilization analytics and generating information reports, and may further include one or more internal data sources 104 (e.g., databases or other servers connected to databases that pre-process the information from the databases) and/or connections to one or more external data sources 120 (e.g., third-party databases from other provider organizations or medical record-keeping organizations) for retrieving claims information. The user computing device 110 is connected to the backend system 101 via a communications network such as through the Internet, utilizing wireless and/or wired connections such as local area network (LAN) protocols, wireless local area network (WLAN) protocols, cellular protocols, etc.

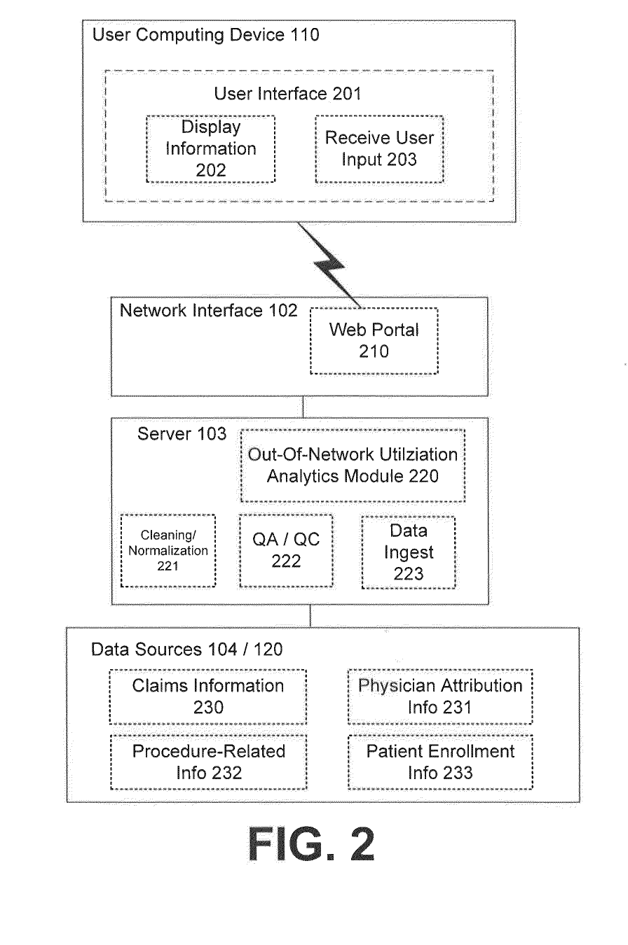

FIG. 2 is a block diagram illustrating in further detail the elements depicted in FIG. 1 and certain functionality corresponding thereto. The user computing device 110 includes a user interface 201 for displaying information 202 (for example, data visualization graphs, reports, and/or maps) based on the patient out-of-network utilization analysis performed by the system backend and for providing inputs 203 to navigate the tool so as to apply different filters and/or present different analyses. In one exemplary implementation, this user interface 201 may be provided, for example, via a browser application installed on the user computing device 110, which displays information generated by the backend system. In another exemplary implementation, this user interface 201 may be provided, for example, via a specific analytics application installed on the user computing device 110, with functionality (such as report generation) being provided by the specific analytics application such that the backend system 101 simply provides data to the user computing device 110 in response to queries by the user computing device, or such that both the user computing device 110 and the backend system 101 perform aspects of generating and formatting the information to be displayed on the user computing device 110.

The backend system 101 provides a network interface 102, which may include a web server configured to provide a web portal 210. The network interface 102 connects the user computing device 110 to the server 103, allowing the user computing device 110 to request and receive information processed by the server 103 (as discussed above, this information may or may not be formatted into an appropriate reporting format prior to reception by the user computing device 110). The server 103 includes an out-of-network utilization analytics module 220, which executes logic (e.g., according to processor-executable instructions stored on a non-transitory computer-readable medium corresponding to the server 103) to process claims information to identify and analyze potential sources of patient out-of-network utilization. The server 103 further includes modules for cleaning and normalization 221, quality assurance and quality control 222, and data ingest 223.

The data ingest module 223 of the server 103 provides an interface for the server 103 to receive claims information and other information from internal and external data sources 104/120. These data sources may include claims information 230, as well as processed claims information (for example, claims information for which additional fields, e.g., pertaining to procedure categorization or physician attribution, have been added). In an exemplary implementation, the information received by the server 103 from the data sources 104/120 further includes physician attribution information 231 (i.e., identifications of the primary physician associated with each claim), and procedure identification and/or categorization information 232. In one particular example, the procedure identification and/or categorization information 232 includes identifications of the specific procedures associated with each claim, as well as identifications of the procedure group, category, and class of each claim—e.g., with over 10,000 procedure identifications are categorized into “major,” “minor,” “diagnostic,” or “other” procedure “classes, with further divisions into 21 procedure categories and 176 procedure groups. The data sources 104/120 may further include patient enrollment information 233, which provides information about patient participation, the patient's address, and other demographic information, and which can be correlated with claims information, for example, based on a patient identification number.

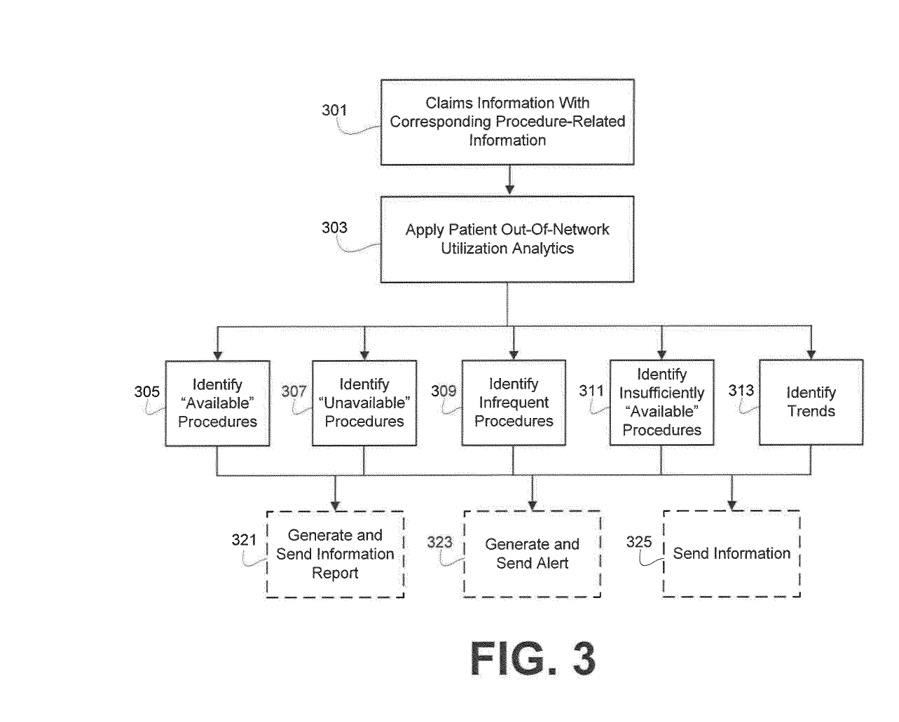

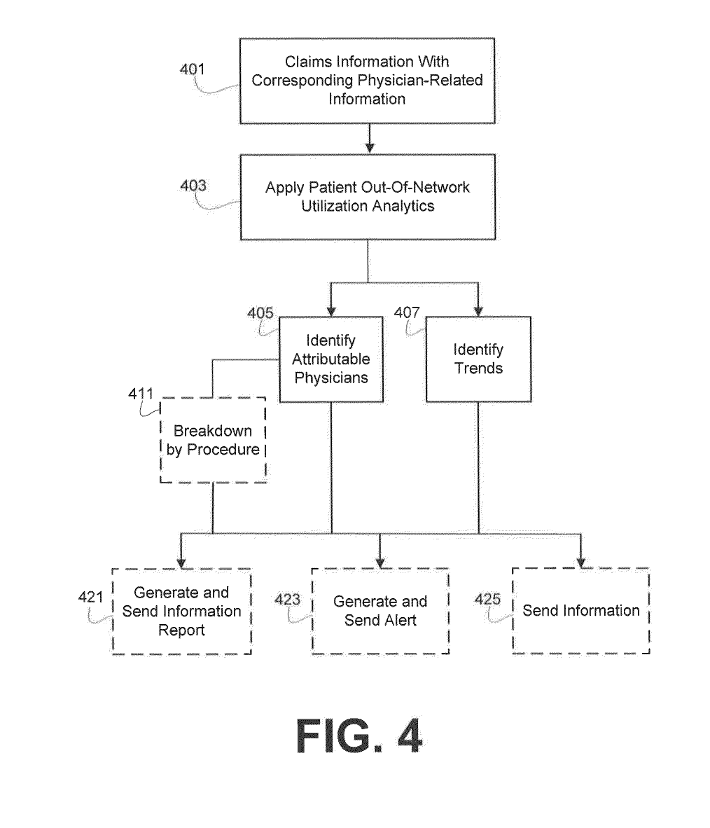

FIGS. 3-4 are flowcharts illustrating exemplary out-of-network utilization analyses that can be performed by out-of-network utilization analytics module 220 to identify sources of patient out-of-network utilization with particularity.

FIG. 3 illustrates a process for identifying whether patient out-of-network utilization might be due to a scarcity or lack of a particular type of medical procedure within a healthcare provider's network is a likely cause of patient out-of-network utilization. At stage 301, the out-of-network utilization analytics module obtains or accesses claims information from one or more data sources with corresponding procedure identification and/or categorization information. In an exemplary embodiment, at stage 303, the out-of-network utilization analytics module then analyzes the information to determine whether patients have been able to obtain particular procedures (or, e.g., procedure groups, categories, or classes) in-network above a threshold amount (the threshold amount may be, for example, a number of in-network procedures or a ratio or percentage of in-network procedures relative to out-of-network procedures or total number of procedures).

If so, the procedures (or, e.g., procedure groups, categories or classes) may be designated as “available” (or “offered”) in-network (stage 305), and if not, the procedures (or, e.g., procedure groups, categories or classes) may be designated as “unavailable” (or “not offered”) in-network (stage 307). This allows reports to be generated regarding which procedures are available and which are not available within the healthcare provider's network, allowing an administrator of the healthcare provider to determine whether to flag instances of out-of-network utilization (e.g., “appropriate” out-of-network utilization that is not flagged could be a patient going out-of-network for a non-offered service, while “inappropriate” out-of-network utilization that is flagged is a patient going out-of-network for an offered service). This further enables the administrator to take appropriate remedial action if needed.

In a further exemplary embodiment, before designating procedures as “available” or “unavailable,” the analysis at stage 303 further considers the amount of out-of-network performances of a procedure (or, e.g., procedure group, category or class) for patients of the health provider's network, and/or that amount in relation to the amount of in-network performances of a procedure (or, e.g., procedure group, category or class) for patients of the health provider's network. These considerations allow the system to determine that a procedure (or, e.g., procedure group, category or class) that is not performed might not necessarily be unavailable in-network (since patients are not going out-of-network for that procedure (or group, category or class) either) (stage 309). These considerations further allow the system to determine whether a procedure (or, e.g., procedure group, category or class) that meets the criteria for being available in-network is still nonetheless a source of patient out-of-network utilization because a large number of patients are also going out-of-network for that procedure (or, e.g., procedure group, category or class) (stage 311). This determination may, for example, be based on the absolute number of patients going out-of-network for that procedure (or, e.g., procedure group, category or class), or may be based on an out-of-network percentage or ratio.

The analysis at stage 303 may be limited to data for a certain time period (e.g., within the past year), if desired, to ensure that the results of the determination are up-to-date. Further, the analysis at stage 303 may identify trends in in-network and/or out-of-network performance of procedures (or, e.g., procedure groups, categories or classes) (stage 313). For example, if over the course of one or two years, or over the course of several months, the ratio of out-of-network performances of a procedure (or, e.g., procedure group, category or class) to in-network performances of that procedure (or, e.g., procedure group, category or class) is increasing, the system identifies the trend and notifies a user that out-of-network utilization is increasing for that procedure (or, e.g., procedure group, category or class).

The process depicted in FIG. 3 may be performed in an on-demand manner—for example, with respect to a user request for an overall summary of information with respect to procedures (or, e.g., procedure groups, categories, or classes) or with respect to a specific user request for particular information with respect to a particular procedure (or, e.g., procedure group, category or class)—to generate a report for a user (stage 321), for example, including graphical and other formats for presentation of the information, and further including interactive elements to allow users to further filter the information presented and query additional details.

The process depicted in FIG. 3 may also be performed in an ongoing manner, with the system monitoring claims information over a time window to identify potentially negative trends (such as an increase in out-of-network performances, a decrease in in-network availability) or triggers (such as out-of-network performances rising over a threshold or in-network performances falling below a threshold) to generate alerts for a user (stage 323).

As discussed above with respect to FIGS. 1 and 2, the report and/or alert generation functionality may be performed by the server, or alternatively may be fully or partially offloaded from the server-side to the client-side user computing device, with unformatted or partially formatted information being sent to the user computer device (stage 325).

FIG. 4 illustrates a process for identifying whether patient out-of-network utilization might be attributable to a particular in-network physician (which may be due to that physician making numerous out-of-network referrals or due to other reasons which may be outside of the physician's control) or to a group of in-network physicians. At stage 401, the out-of-network utilization analytics module obtains or accesses claims information with corresponding physician attribution information. In an exemplary embodiment, at stage 403, the out-of-network utilization analytics module then analyzes the data to determine whether particular physicians are associated with a large amount of out-of-network utilization or a high percentage of out-of-network utilization. This allows reports to be generated regarding which in-network physicians might be associated with patient out-of-network utilization, allowing an administrator of the healthcare provider and/or the physician to investigate and take appropriate remedial action if needed.

Similar to the discussion above with respect to stage 303 of FIG. 3, the analysis at stage 403 may be limited to a particular time period, may be used to identify trends (stage 405), and may be implemented on an on-demand or ongoing manner, with reports and alerts being generated (stages 421 and 423). The information may also be sent in an unformatted or partially-formatted form (stage 425). In a further exemplary embodiment, the procedure-related data discussed above with respect to FIG. 3 is also used with respect to the process of FIG. 4 to further determine whether particular in-network physicians are associated with out-of-network utilization in general or within the context of only specific procedures (or, e.g., procedure groups, categories or classes) (stage 411).

The processes discussed above with respect to FIGS. 3 and 4 may also be used in connection with other claims information to identify sources of out-of-network utilization relating to other parameters and fields of the claims information. For example, instead of or in addition to analyzing out-of-network utilization corresponding to physicians at stage 403 of FIG. 4, an analysis may be performed with respect to health plans corresponding to claims information to identify whether certain health plans are associated with patient out-of-network utilization (e.g., due to unavailability of services, payor type, benefit design, or other reasons such as pricing). Similarly, other parameters such as location of services facilities or physician offices, lack of capacity or quality of services for particular specialties (e.g., in general or relative to patient demand), and/or cost of services can be considered under the same analytics framework to identify possible correlations between such parameters and patient out-of-network utilization.

The processes in FIGS. 3-4 can also be adapted to additionally provide for identification of which out-of-network providers are providing healthcare services to in-network patients (e.g., based on the out-of-network physicians treating those patients). Knowing which out-of-network providers patients—as well as their geographic locations relative to in-network providers and patients—is useful to a healthcare administrator (e.g., an ACO, hospital, or other provider) to evaluate their in-network coverage and to determine how to improve patient retention. Such evaluations may be based on trend information (e.g., trends in how many patients, services, dollars received by an out-of-network provider from certain in-network providers and/or the types of procedures received by the out-of-network provider from in-network patients) similar to the trend information discussed above with respect to FIGS. 3 and 4.

Thus, the out-of-network utilization analytics module of this system provides a flexible and robust tool with which a health provider administrator or other user can effectively identify potential sources of patient out-of-network utilization with particularity, putting them into a better position to quickly and effectively redress any identified issues.

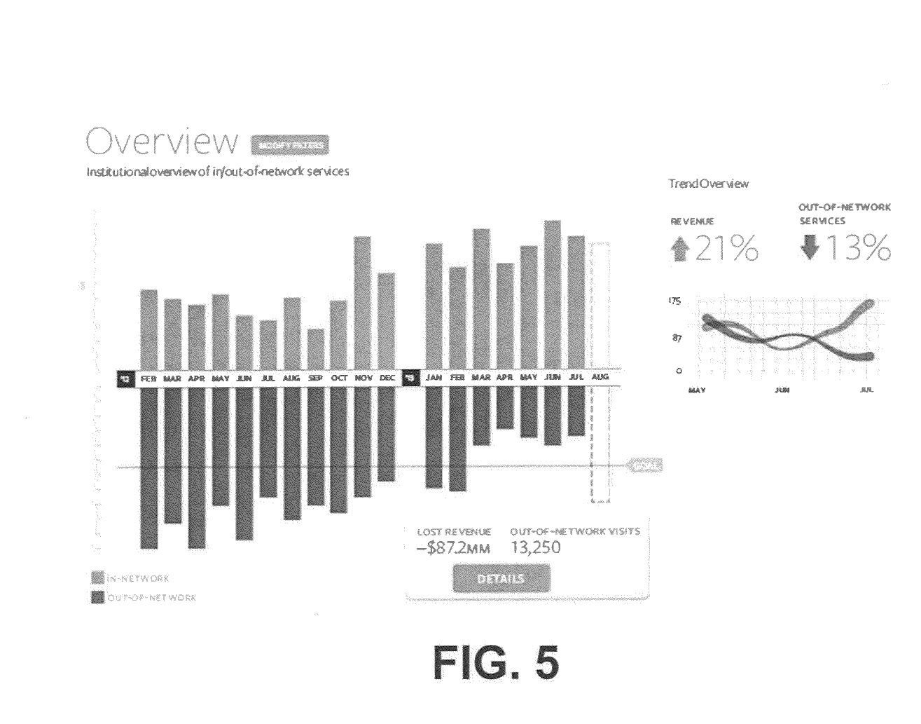

FIGS. 5-11 are exemplary screens illustrating a user interface presented to the user of a user computing device for reporting patient out-of-network utilization-related information.

FIG. 5 illustrates an exemplary overview reporting screen, which shows revenue from in-network patient visits (top half of the bar graph) versus lost revenue attributable to out-of-network utilization (i.e., “out-of-network patient visits) (bottom half of the bar graph) on a month-by-month basis. Trend information is also presented on the right side of the screen, indicating an increase in in-network revenue and a decrease in out-of-network services provided.

The screen is also interactive, allowing a user to select (e.g., by clicking a mouse or tapping a touchscreen) an area of the screen to provide more detailed information—particularly, FIG. 5 depicts that the out-of-network bar for February 2013 has been selected, and a particular dollar amount of “Lost Revenue” and number of out-of-network visits for that month is displayed with a further option of selecting the “Details” button for even more information. The screen also allows for filtering of the data presented by selecting the “Modify Filters” option, which brings up a variety of settings that are configurable by a user (e.g., to display data pertaining to: managed patients or fee-for-service patients or both; employed physicians or affiliated physicians or both; offered services or non-offered services or both; a specified timeframe; specified institutions, groups, or entities; etc.).

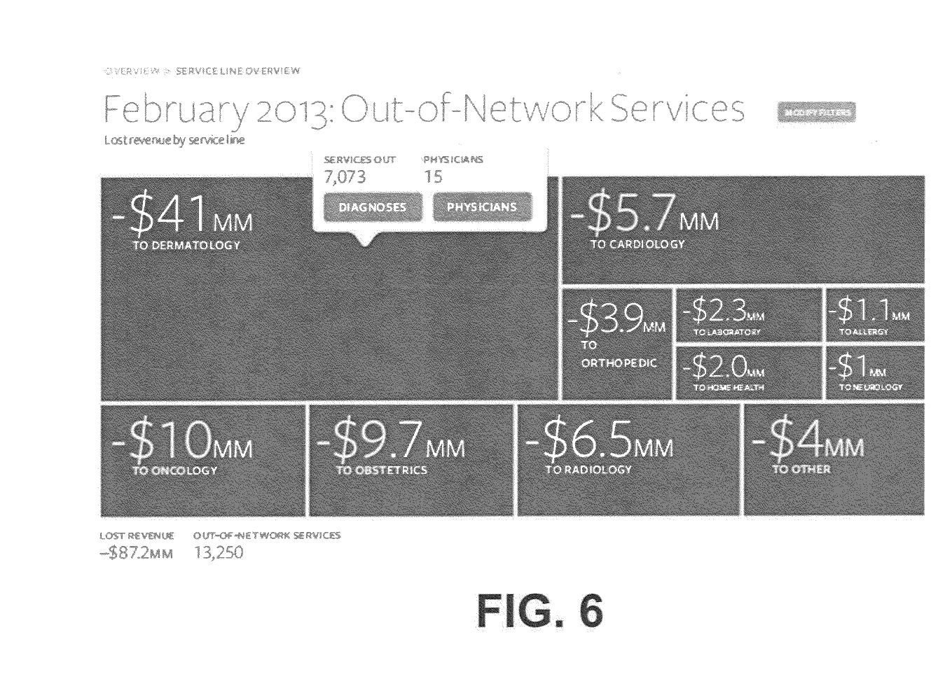

FIG. 6 illustrates a screen that is presented to the user after the user selects the “Details” button shown in FIG. 5 corresponding to out-of-network services from February 2013. In this example, a detailed breakdown of lost revenue by “service line” (e.g., a category of medical procedures) is given, showing the particular amount of lost revenue corresponding to out-of-network services from each of a plurality of service lines. This information is obtained, for example, via the patient out-of-network utilization analysis discussed above with respect to FIG. 3.

Further, in the example provided by FIG. 6, the user has selected the “−$41 MM to Dermatology” area of the screen to obtain more information, showing that in the Dermatology service line, there were 7,073 out-of-network services performed in February 2013 and that 15 in-network physicians had attributed patients that went out-of-network for services. Further selecting the “Diagnoses” or “Physicians” buttons presents a new screen to the user with even further detail.

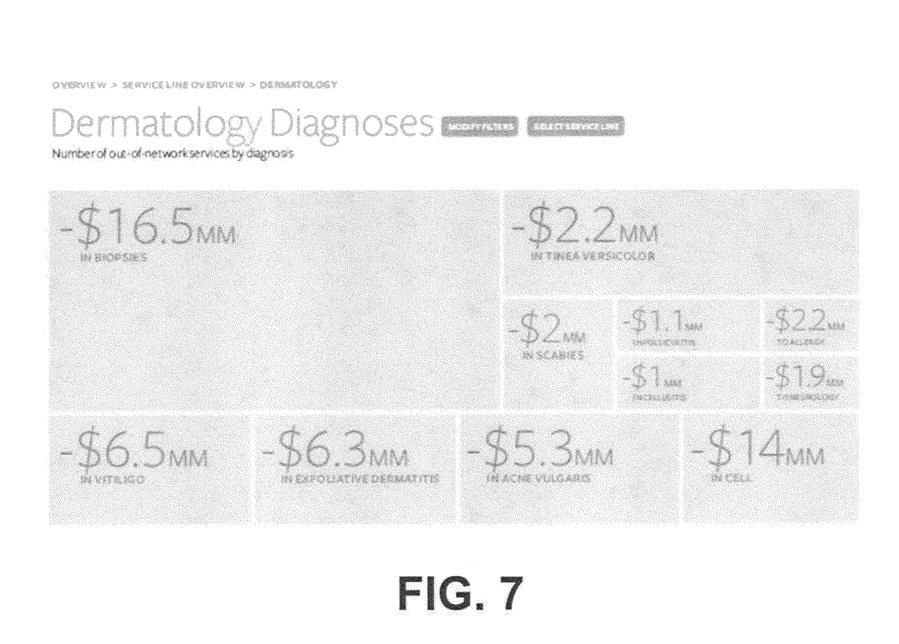

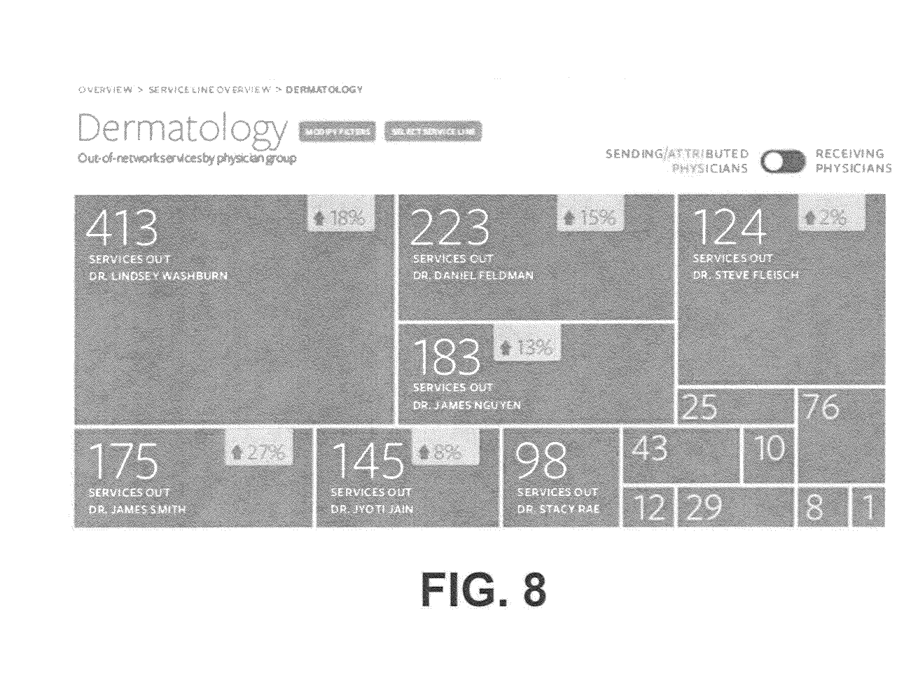

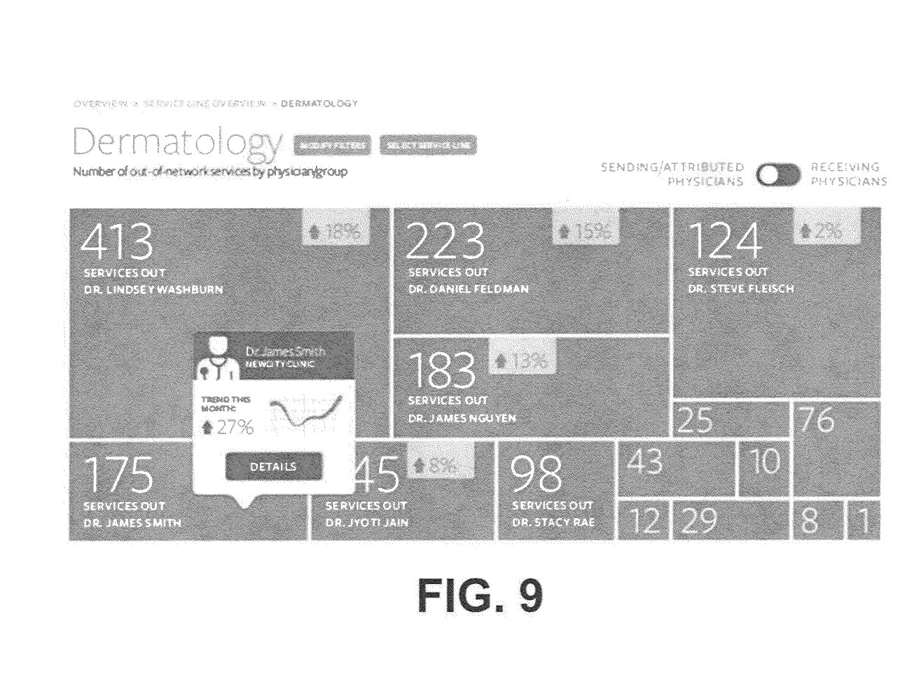

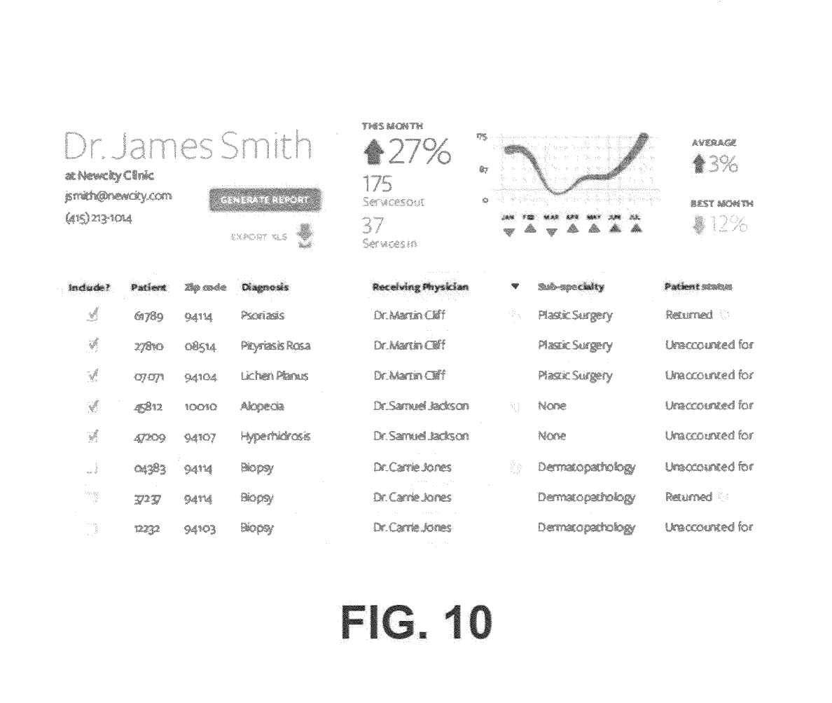

FIGS. 7 and 8 provide exemplary “Diagnoses” and “Physicians” screens based on the “Diagnoses” and “Physicians” buttons shown in FIG. 6, respectively. The exemplary “Diagnoses” screen provides an even more detailed procedure-related breakdown, providing specific information regarding how much of the $41 MM lost due to out-of-network utilization were attributable to each of a plurality of diagnoses (e.g., biopsies, vitiligio, tinea versicolor, etc.). Similarly, the exemplary “Physicians” screen provides a physician-based breakdown within the context of Dermatology, providing specific information regarding how many of the 7,073 out-of-network services were attributable to each of a plurality of physicians. These further “Diagnoses” and “Physicians” screens also provide filtering options (similar to as discussed above with respect to FIG. 5), and further include additional options for obtaining even more detailed information. For example, FIGS. 9 and 10 illustrate screens corresponding to even more specific information obtained with respect to a specific doctor appearing on the “Physicians” screen of FIG. 8, including trend information and specific claim information. FIG. 10 further shows that the user has the option to generate a report document in another format (e.g., for printing) or exporting the data to a spreadsheet (“Export xls”). FIGS. 8 and 9 further include the option to toggle between viewing data pertaining to in-network “sending/attributed physicians” and viewing data pertaining to out-of-network “receiving physicians” corresponding to the detailed out-of-network utilization information.

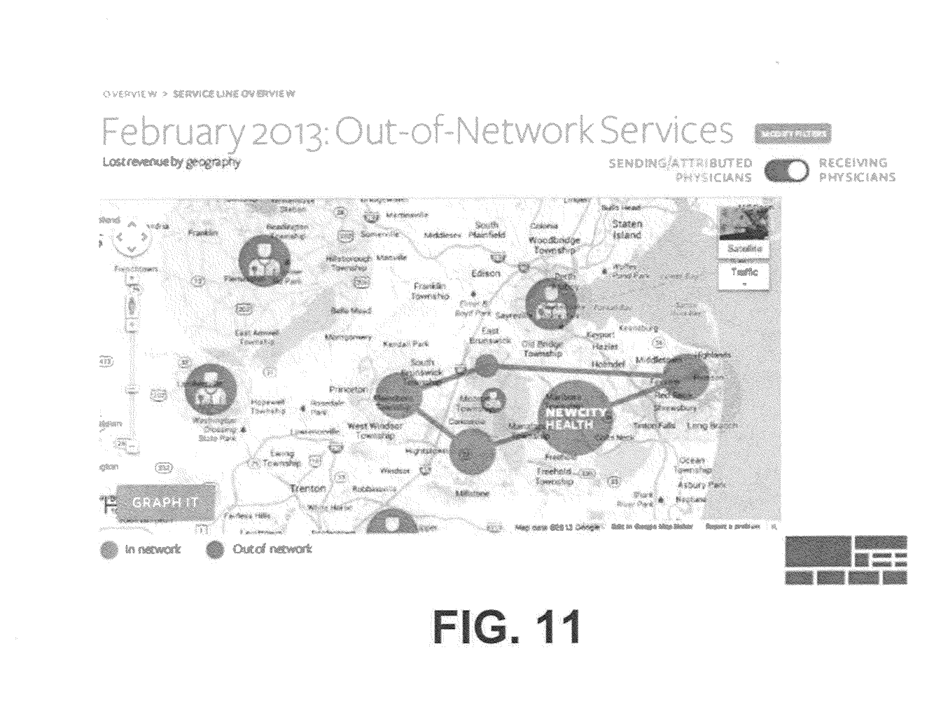

FIG. 11 illustrates an exemplary screen that shows an alternative, map-based report for displaying geographic information relating to out-of-network utilization. In the example depicted by FIG. 11, the “Newcity Health” network is indicated by the 5 joined circular areas, while out-of-network physicians receiving patients under the “Neweity Health” network are indicated by the other circular areas with physician icons. This screen thus provides a convenient way for a user to ascertain the amount and/or value of out-of-network services being provided by out-of-network physicians in different geographic areas (the greater the radius, the larger the amount and/or value of services performed). The screen further includes various interactive options, such as the ability to apply filters, or to change the report format to a graphical or square-based view. The screen in FIG. 11 further includes the option to toggle between viewing the geographic locations of “sending/attributed physicians” versus “receiving physicians” (e.g., to ascertain where both in-network and out-of-network receiving physicians are located, as well as where both in-network and out-of-network sending physicians are located—with in-network and out-of-network physicians being distinguished in both display options, for example, by color).

It will be appreciated that the screens depicted in FIGS. 5-11 are merely examples, and that the information capable of being reported and the manners in which the information may be reported by various embodiments of the invention are not limited to the exemplary screens of FIGS. 5-11.

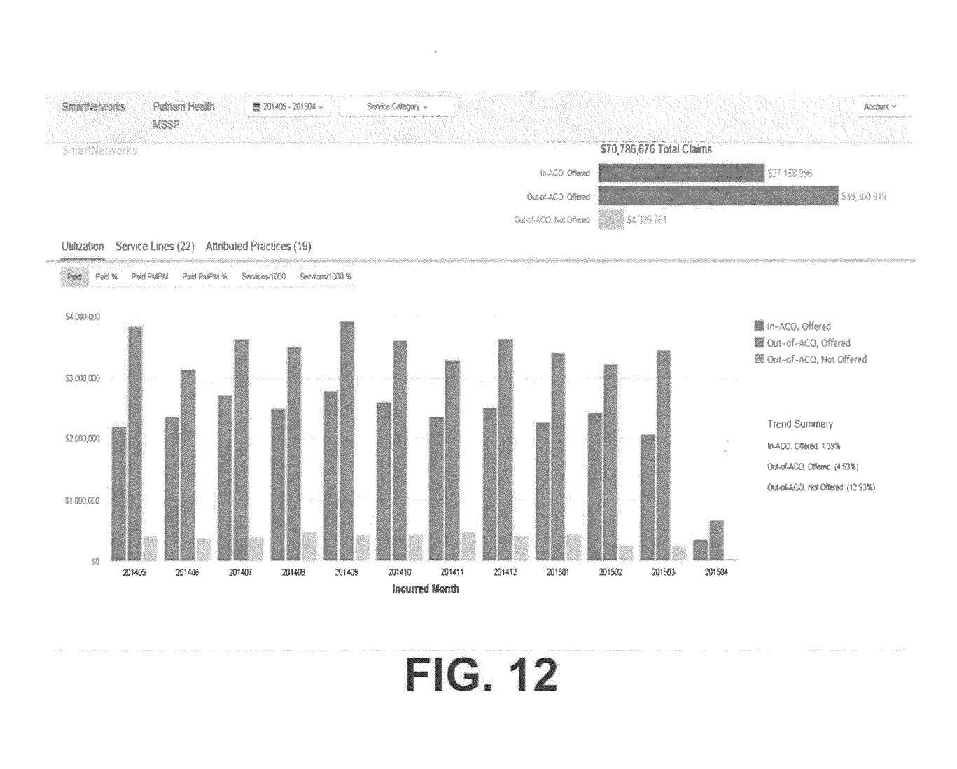

FIGS. 12-27 illustrate examples of graphical user interface (GUI) screens associated with another exemplary interactive GUI generated by the analysis system discussed above for reporting various in-network/out-of-network utilization and claims-related information. The interactive GUI includes various different screens for providing different information reports, and the screens include interactive elements (e.g., buttons that may be clicked on using a mouse device or tapped on via a touchscreen) for navigating between the different screens and/or for causing additional detailed information to be displayed.

FIG. 12 is an example of a graphical user interface (GUI) screen providing information regarding total payment amounts for in-network and out-of-network services (including offered and non-offered out-of-network services).

In the top right corner, a total dollar amount of claims for the time period of the report (May 2014-April 2015) is displayed, with dollar amounts and corresponding color-coded bar representations for the dollar amounts of claims for in-network services (which by definition are offered), out-of-network services that are offered, and out-of-network services that are not offered.

The GUI screen in FIG. 12 also includes a first bar of displayed/interactive elements corresponding to “Utilization” (underlined because it is the currently active view), “Service Lines (22)” (which forms an interactive element that may be selected by the user to navigate to a GUI screen relating to the professional service lines associated with the claim information, of which there are 22 different types), and “Attributed Practices (19)” (which forms an interactive element that may be selected by the user to navigate to a GUI screen relating to the attributed practices associated with the claims information, of which there are 19 different practices).

The GUI screen in FIG. 12 further includes a second bar of displayed/interactive elements corresponding to “Paid” (highlighted in a different color from the other elements of the bar because it is the currently active view), as well as “Paid %,” “Paid PMPM,” “Paid PMPM %,” “Services/1000,” and “Services/1000%” (which each form an interactive element that may be selected by the user to navigate to other respective GUI screens).

As mentioned above, the currently active view depicted in the GUI screen of FIG. 12 pertains to overall utilization for claims over the time period of May 2014 to April 2015, and provides a plot illustrating the “Paid” information over that period broken down by month. Each month has three bars associated with it in the plot, with a first bar corresponding to payments for in-network services, a second bar corresponding to payments for out-of-network services that are offered in network, and a third bar corresponding to payments for out-of-network services that are not offered in network.

A legend may further be provided which color bar corresponds to which category of information, as illustrated to the right of the plot in FIG. 12. Although it will be appreciated that the drawings herein are provided in grayscale, exemplary implementations of the GUI may utilize different colors for the data displayed and the corresponding elements on the legend to visually distinguish the different types of data being displayed.

The area at the top of FIG. 12 provides information regarding the ACCO or provider (e.g., “Putnam Health MSSP” in this example), an interactive element corresponding to the selected time period for the information being reported, an interactive element corresponding to the reporting period reflected in the GUI (e.g., the interactive element may be a filter element that is currently set to May 2014 through April 2015 in this example, and may accept user input to change the reporting period to a different time period), and an interactive element corresponding to the service categories being displayed (e.g., the interactive element may be a filter element that is currently set to display all service categories in this example, and may accept user input to change the service categories being displayed to one or more of a number of specific categories, such as in-patient, out-patient, professional, pharmacy, etc.). The “Account” interactive element in the top right of FIG. 12 corresponds to user account-related functionality (for example, interacting with this element may allow the user to sign out, change their password, or perform other account-related functions).

Trend information may also be provided as well, as illustrated to the right of the plot in FIG. 12. The trend information provides a percentage change relative to a previous time period of the same length of the current reporting period. Thus, in the present example, the trend information corresponds to the percentage change for in-network, out-of-network (offered) and out-of-network (not offered) claim payment amounts for the time period May 2014-April 2015 relative to the time period May 2013-April 2014. In this example, there was a 1.38% increase for in-network claim payments, a 4.53 decrease for out-of-network claim payments for offered services, and a 12.83% decrease for out-of-network claim payments for non-offered services.

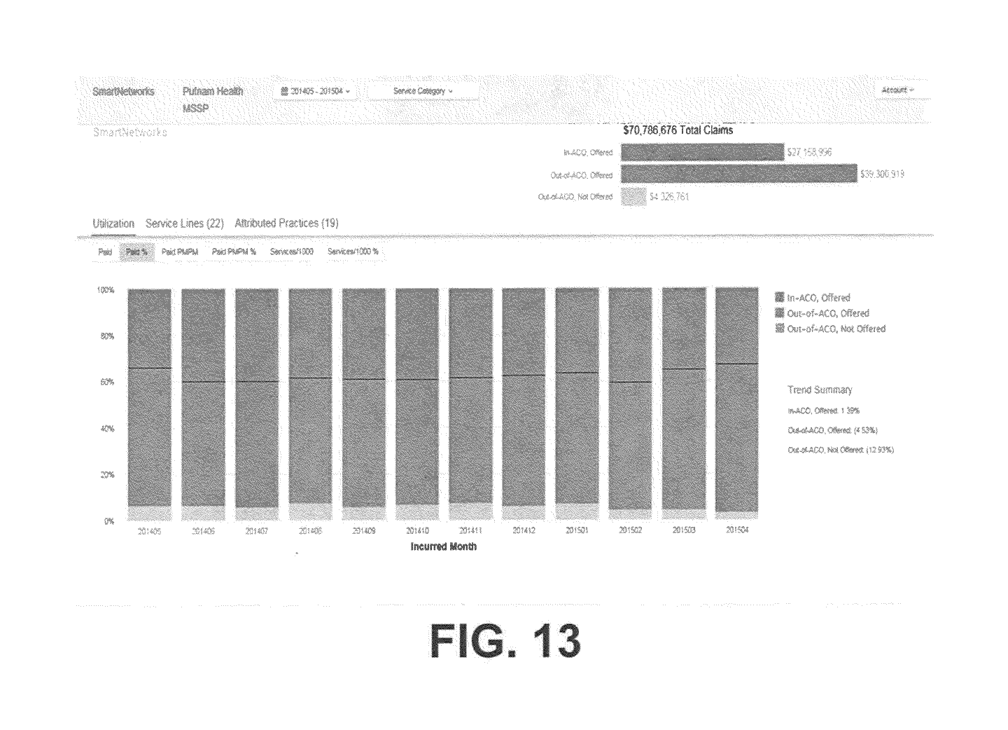

FIG. 13 is an example of a GUI screen providing information regarding payment percentages for in-network and out-of-network services (including offered and non-offered out-of-network services). The GUI screen shown in FIG. 13 may be reached, for example, by receiving a user input corresponding to the “Paid %” interactive element in the GUI screen shown in FIG. 12.

Receiving this input causes the interactive GUI to switch the active view to the GUI screen of FIG. 13, which pertains to overall utilization for claims over the time period of May 2014 to April 2015, and provides a plot illustrating the “Paid %” information over that period broken down by month. It will be appreciated that, correspondingly, the “Utilization” element in the first status bar from FIG. 12 remains underlined in FIG. 13, while the highlighted element in the second status bar changes to the “Paid %” element to reflect that the “Paid %” information is displayed by the current GUI screen.

Each month has a separate bar from 0-100% associated with it in the plot, with each 0-100% bar being broken down into three color-coded subparts corresponding to the percentage of total payments corresponding to in-network services, the percentage of total payments corresponding to out-of-network services that are offered in network, and the percentage of total payments corresponding to out-of-network services that are not offered in network, respectively.

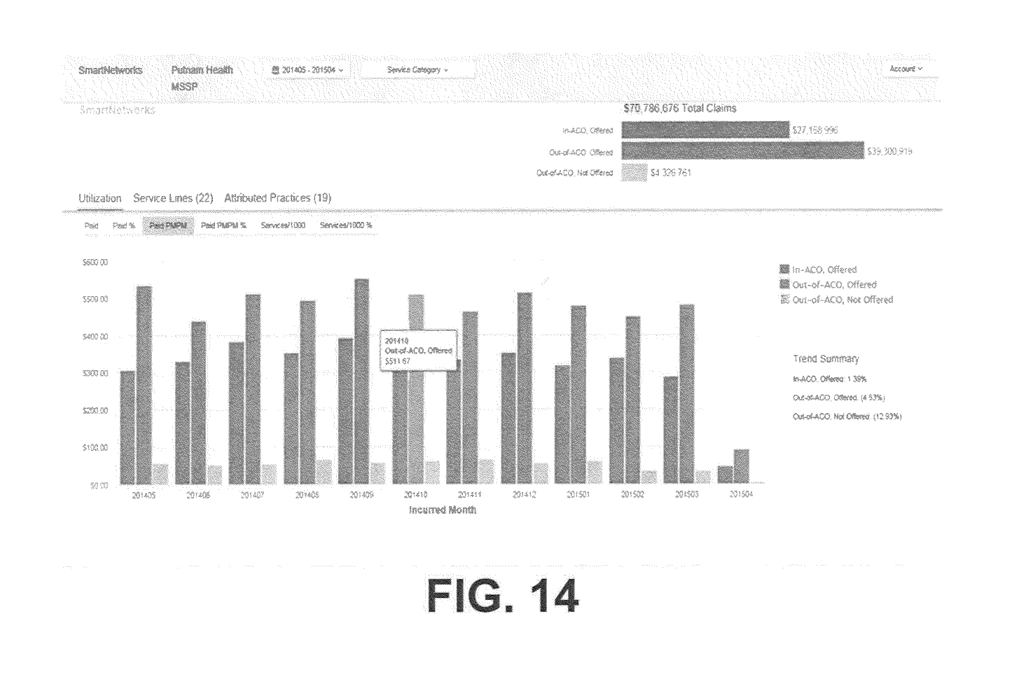

It will be appreciated that the total claims information, the color-coded legend, and the trend summary information depicted in FIG. 12 may be maintained or repeated in the GUI screen of FIG. 13 (as well as FIGS. 14-17), as these display elements may be relevant to the information depicted in each of FIGS. 12-17. The top portion and the status bars may also be repeated, as they provide interactive elements for navigation and/or relevant information regarding the report.

FIG. 14 is an example of a GUI screen providing information regarding payment amounts per member per month (PMPM) for in-network and out-of-network services (including offered and non-offered out-of-network services). The GUI screen shown in FIG. 14 may be reached, for example, by receiving a user input corresponding to the “Paid PMPM” interactive element in either of the GUI screens shown in FIG. 12 or 13.

Receiving this input causes the interactive GUI to switch the active view to the GUI screen of FIG. 14, which pertains to overall utilization for claims over the time period of May 2014 to April 2015, and provides a plot illustrating the “Paid PMPM” information over that period broken down by month. It will be appreciated that, correspondingly, the “Utilization” element in the first status bar from FIGS. 12 and 13 remains underlined in FIG. 14, while the highlighted element in the second status bar changes to the “Paid PMPM” element to reflect that the “Paid PMPM” information is displayed by the current GUI screen.

Each month has three bars associated with it in the plot, with a first bar corresponding to payments PMPM for in-network services, a second bar corresponding to payments PMPM for out-of-network services that are otfered in network, and a third bar corresponding to payments PMPM for out-of-network services that are not offered in network. The payments PMPM correspond to the amount paid to the provider by the plan per member per month, and the payments PMPM for a time period may be based on the paid amount divided by a number of members and a number of months in the time period.

FIG. 14 further includes a pop-up display element shown corresponding to the specific out-of-network payments PMPM for October 2014. This pop-up display element may be activated, for example, based on a user selection of the bar associated with payments PMPM for out-of-network services that are offered in network for October 2014 in the plot (e.g., by hovering the mouse over the bar or via a mouse click or a touchscreen tap). It will be appreciated that other pop-up display elements may similarly be activated with respect to other display elements, such as the various other bars shown in FIG. 14 and various displayed elements in FIGS. 12-13 and 15-26.

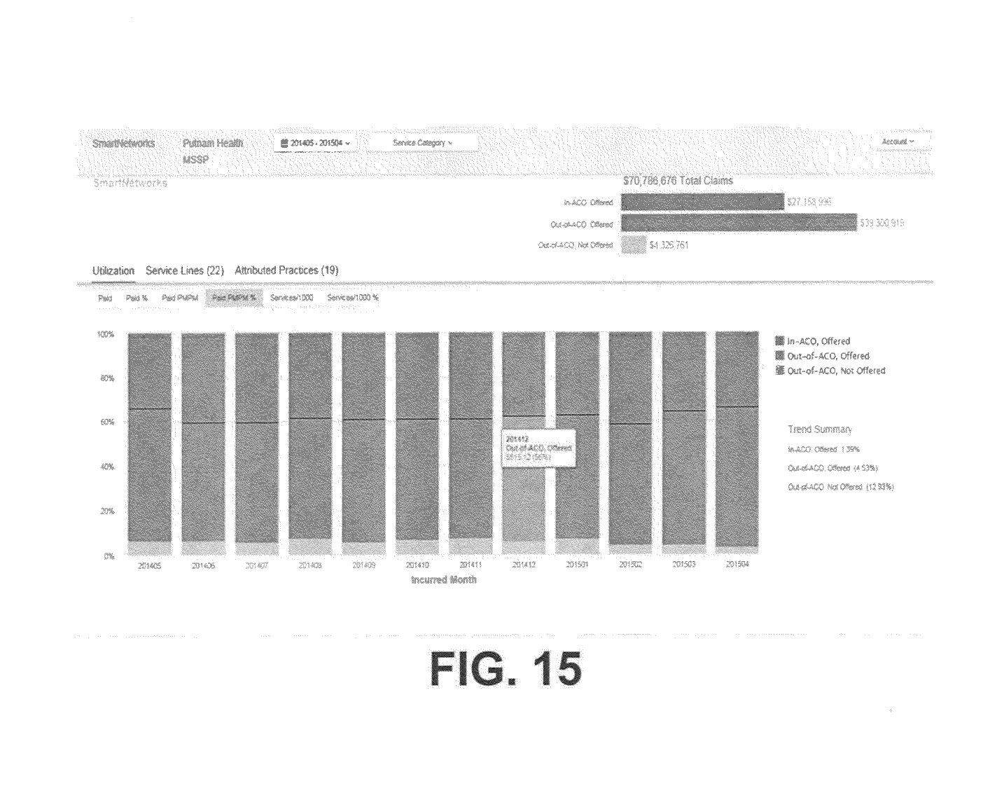

FIG. 15 is an example of a GUI screen providing information regarding payment percentages per member per month (PMPM) for in-network and out-of-network services (including offered and non-offered out-of-network services). The GUI screen shown in FIG. 15 may be reached, for example, by receiving a user input corresponding to the “Paid PMPM %” interactive element in any of the GUI screens shown in FIGS. 12-14.

Receiving this input causes the interactive GUI to switch the active view to the GUI screen of FIG. 15, which pertains to overall utilization for claims over the time period of May 2014 to April 2015, and provides a plot illustrating the “Paid PMPM %” information over that period broken down by month. It will be appreciated that, correspondingly, the “Utilization” element in the first status bar from FIGS. 12-14 remains underlined in FIG. 15, while the highlighted element in the second status bar changes to the “Paid PMPM %” element to reflect that the “Paid PMPM %” information is displayed by the current GUI screen.

Similar to FIG. 13, each month has a separate bar from 0-100% associated with it in the plot, with each 0-100% bar being broken down into three color-coded subparts corresponding to the percentage of total payments PMPM corresponding to in-network services, the percentage of total payments PMPM corresponding to out-of-network services that are offered in network, and the percentage of total payments PMPM corresponding to out-of-network services that are not offered in network, respectively. FIG. 15 further includes a pop-up display element corresponding to the specific percentage of out-of-network payments per member for services that are offered in network out of total network payments per member for December 2014, as well as the amount for the out-of-network payments per member for offered services.

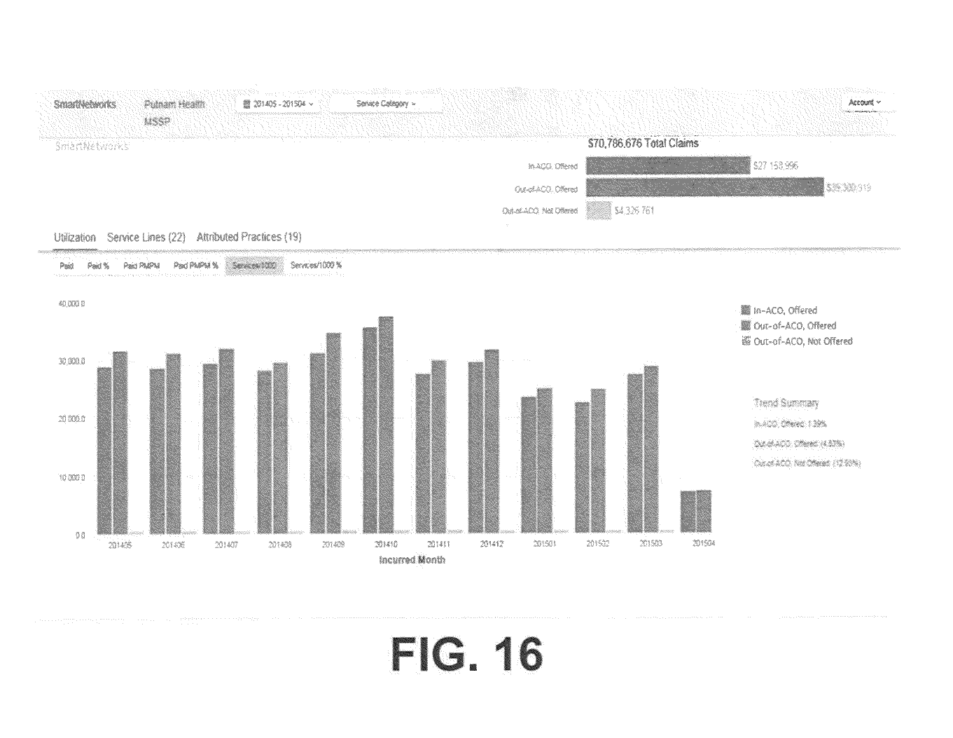

FIG. 16 is an example of a GUI screen providing information regarding a total number of visits per 1000 members for in-network and out-of-network services (including offered and non-offered out-of-network services). The GUI screen shown in FIG. 16 may be reached, for example, by receiving a user input corresponding to the “Services/1000” interactive element in any of the GUI screens shown in FIGS. 12-15.

Receiving this input causes the interactive GUI to switch the active view to the GUI screen of FIG. 16, which pertains to overall utilization for claims over the time period of May 2014 to April 2015, and provides a plot illustrating the “Services/1000” information over that period broken down by month. It will be appreciated that, correspondingly, the “Utilization” element in the first status bar from FIGS. 12-15 remains underlined in FIG. 16, while the highlighted element in the second status bar changes to the “Services/1000” element to reflect that the “Services/1000” information is displayed by the current GUI screen.

Each month has three bars associated with it in the plot, with a first bar corresponding to number of services per 1000 members for in-network services, a second bar corresponding to number of services per 1000 members for out-of-network services that are offered in network, and a third bar corresponding to number of visits per 1000 members for out-of-network services that are not offered in network. The number of services per 1000 members for a time period may be the number of services per member during that time period multiplied by 1000.

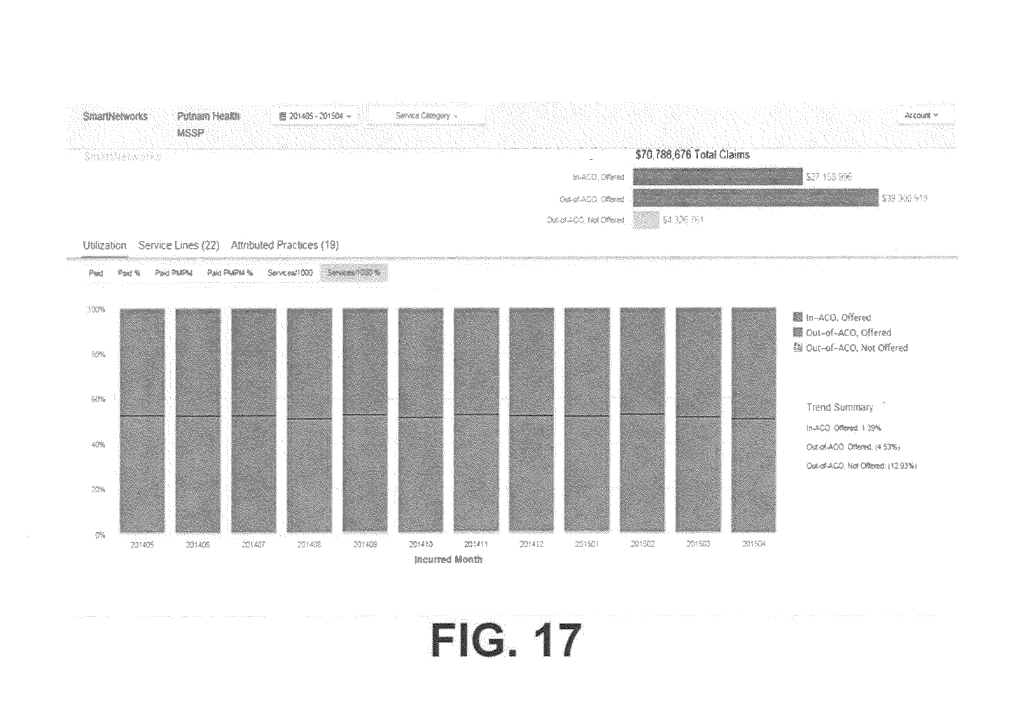

FIG. 17 is an example of a GUI screen providing information regarding percentages of visits per 1000 members for in-network and out-of-network services (including offered and non-offered out-of-network services). The GUI screen shown in FIG. 16 may be reached, for example, by receiving a user input corresponding to the “Services/1000%” interactive element in any of the GUI screens shown in FIGS. 12-16.

Receiving this input causes the interactive GUI to switch the active view to the GUI screen of FIG. 17, which pertains to overall utilization for claims over the time period of May 2014 to April 2015, and provides a plot illustrating the “Services/1000%” information over that period broken down by month. It will be appreciated that, correspondingly, the “Utilization” element in the first status bar from FIGS. 12-16 remains underlined in FIG. 17, while the highlighted element in the second status bar changes to the “Services/1000%” element to reflect that the “Services/1000” information is displayed by the current GUI screen.

Each month has a separate bar from 0-100% associated with it in the plot, with each 0-100% bar being broken down into three color-coded subparts corresponding to the percentage of total services corresponding to in-network services, the percentage of total services corresponding to out-of-network services that are offered in network, and the percentage of total services corresponding to out-of-network services that are not offered in network, respectively.

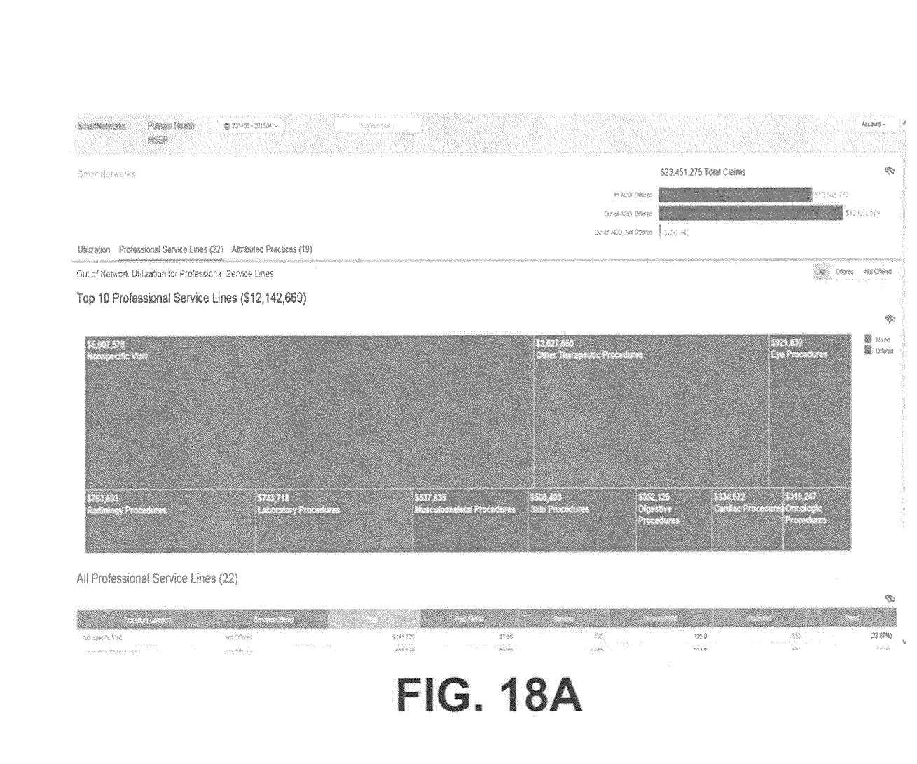

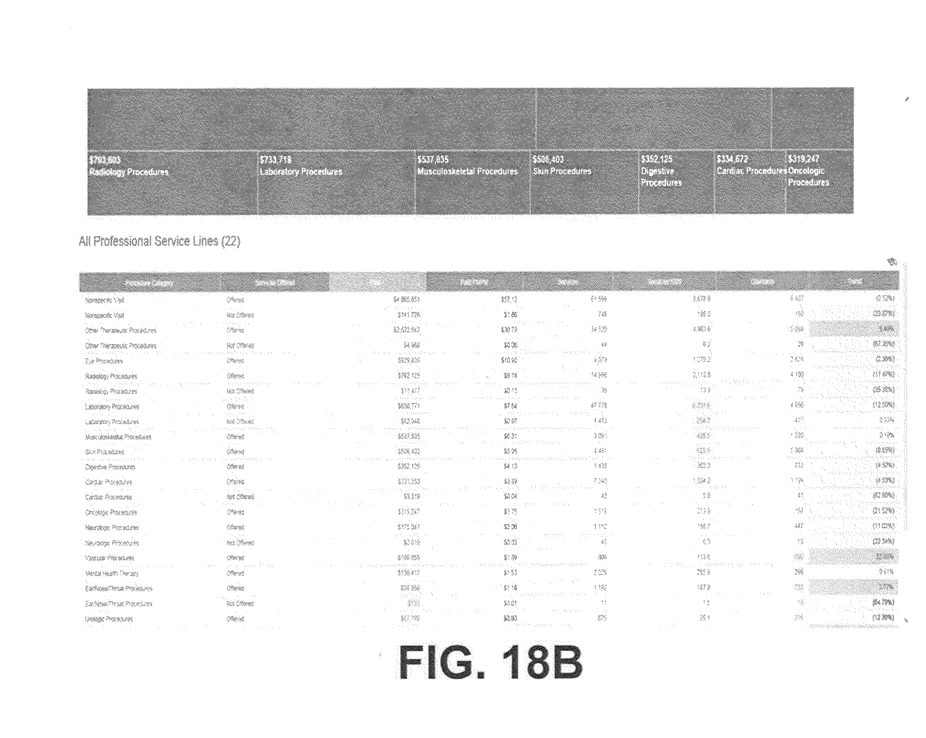

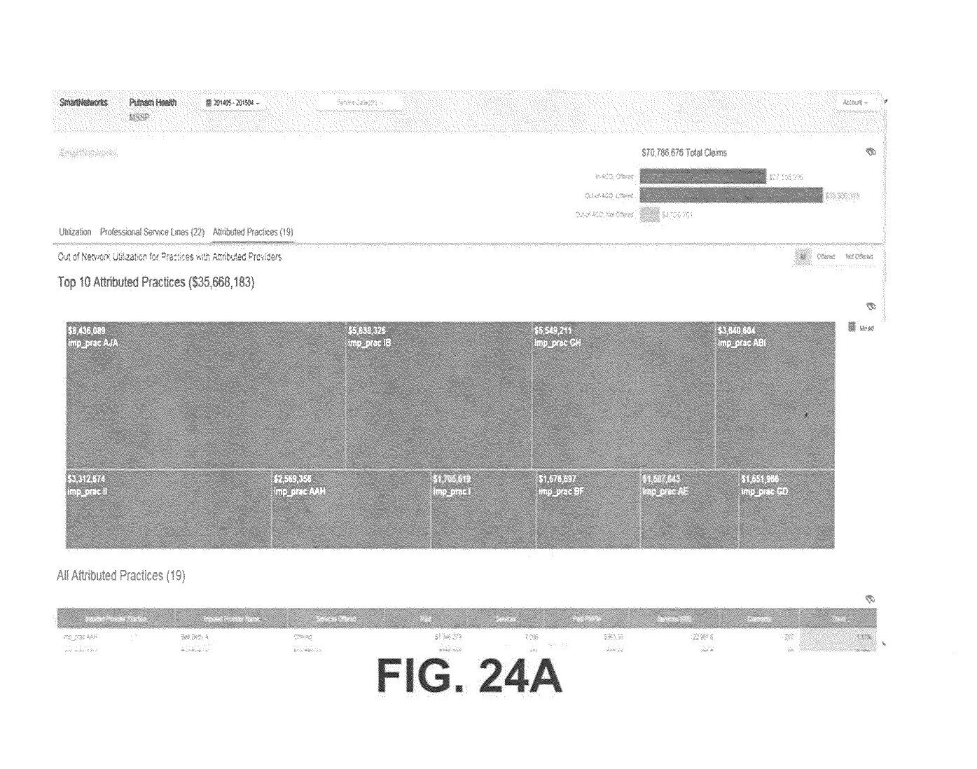

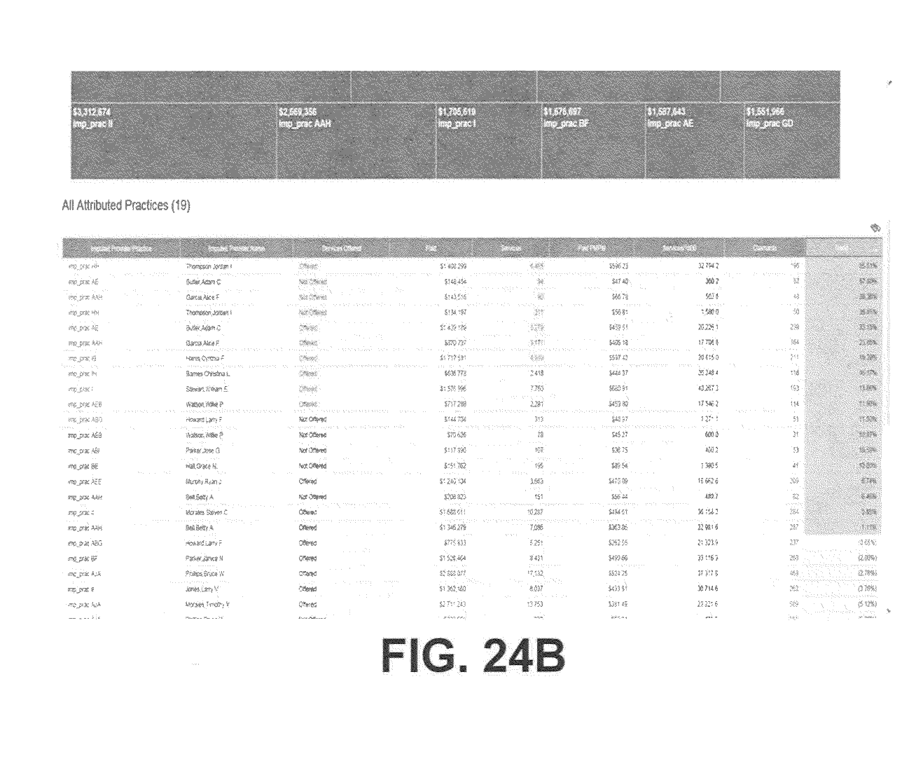

FIGS. 18A-23 and FIGS. 24A-27 corresponding to two different pathways for reporting out-of-network utilization network information, respectively. FIGS. 18A-23 correspond to analyzing out-of-network utilization based on the type of service being offered (e.g., based on service line, procedure group, specific procedure, and specific claims), whereas FIGS. 24A-27 correspond to analyzing out-of-network utilization based on attributed practices and/or medical care providers (e.g., to identify which practices or providers may be causing patients to go out-of-network for services).

FIGS. 18A-18B are examples of GUI screens providing information regarding professional services lines corresponding to both in-network and out-of-network services (including offered and non-offered out-of-network services). The GUI screen shown in FIGS. 18A-18B may be reached from the GUI screens shown in FIGS. 12-17, for example, by receiving a user input corresponding to changing the GUI reporting interface from an “all services” view (where the “Service Category” is shown at the top of the screen) to a “professional services” view (where “Professional” is shown instead of “Service Category” at the top of the screen), and by selecting the “Professional Service Lines (22)” element from a first status bar of the “professional services” GUI. FIG. 18A shows a relatively higher portion of the GUI, and, after scrolling down using the scroll bar on the right hand side, the user may reach the information depicted in FIG. 18B.

FIG. 18A shows out-of-network utilization information for the top 10 professional service lines, which amounts to $12,142,669 in this example. The dollar amounts and names of the top 10 professional service lines are depicted in rectangular display elements, with the sizes of the rectangles being approximately proportional to the dollar amounts. These rectangular display elements may be color-coded in different colors, for example, having three different colors corresponding to “mixed,” “offered,” and “not offered,” respectively. “Mixed” professional service lines are those for which there was out-of-network utilization with respect to both offered and not offered services. “Offered” professional service lines are those for which there was out-of-network utilization only with respect to offered services, and “Not Offered” professional service lines are those for which there was out-of-network utilization only with respect to non-offered services. In this example, the top 10 professional service lines only include mixed and offered professional service lines, and thus only two types of color-coded rectangular display elements are used, with corresponding legend elements on the right. It will be appreciated that although FIG. 18A, as well as the other figures, are shown in grayscale, these display elements may be colored in practice to make them easier to distinguish visually.

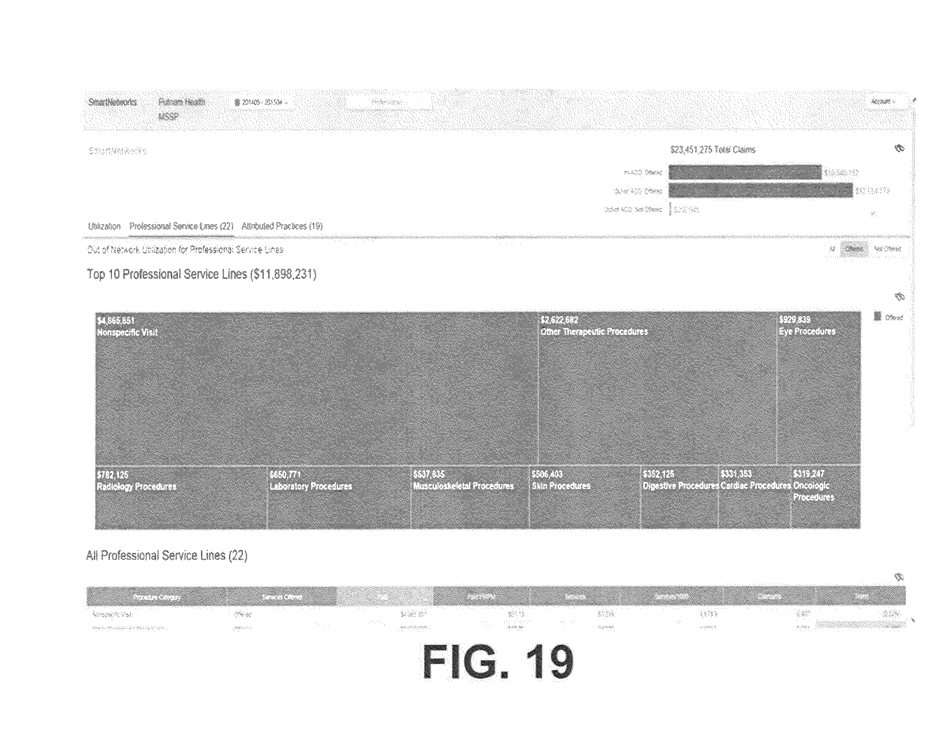

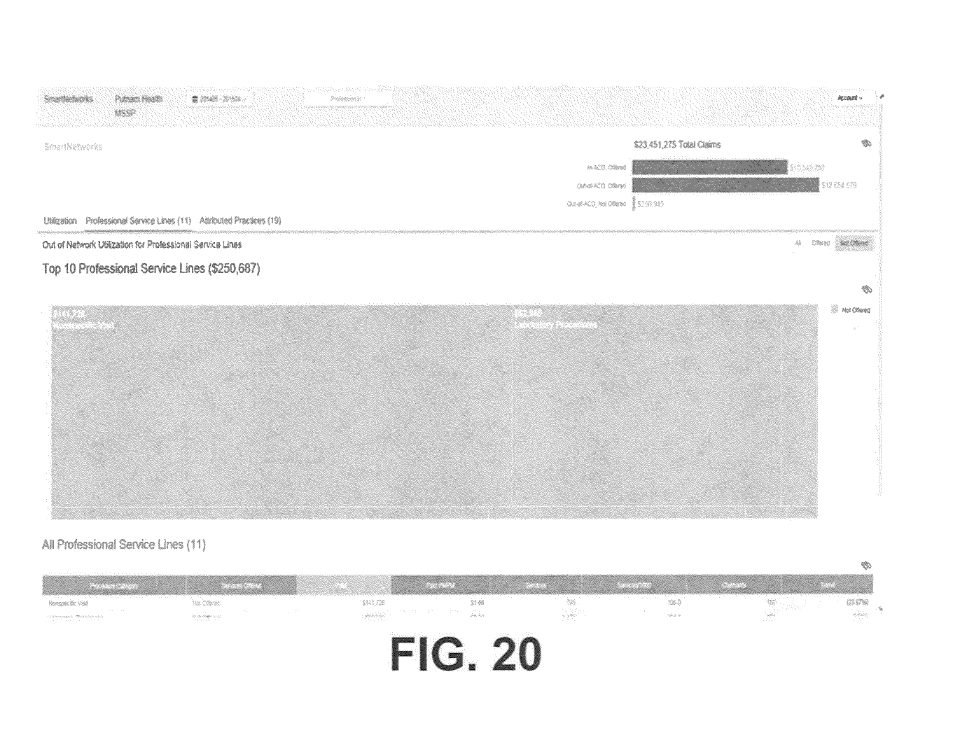

FIG. 18A includes a status bar including “All,” “Offered,” and “Not Offered” interactive elements corresponding to different reporting options. The “All” element is highlighted because the current view corresponds to showing data from all of the “mixed,” “offered,” and “not offered” categories. If the “Offered” element were selected, only information pertaining to out-of-network utilization for offered services is reported (as shown in FIG. 19). If the “Not Offered” interactive element is selected, only information pertaining to out-of-network utilization for non-offered services is reported (as shown in FIG. 20).

FIG. 18B shows detailed out-of-network utilization information for all 22 professional service lines in tabular format, including columns for name of procedure category, distinguishing between offered/not offered information (rows labeled “Offered” correspond to information for offered services within the procedure category, while rows labeled “Not Offered” correspond to information for non-offered services within the procedure category), payment amounts, payment amounts PMPM, number of services, services/1000, number of claimants, and trend information. It will be appreciated that the trend information may be color-coded to show whether the percentage corresponds to an increase or decrease in out-of-network utilization (e.g., with green corresponding to a decrease and red corresponding to an increase).

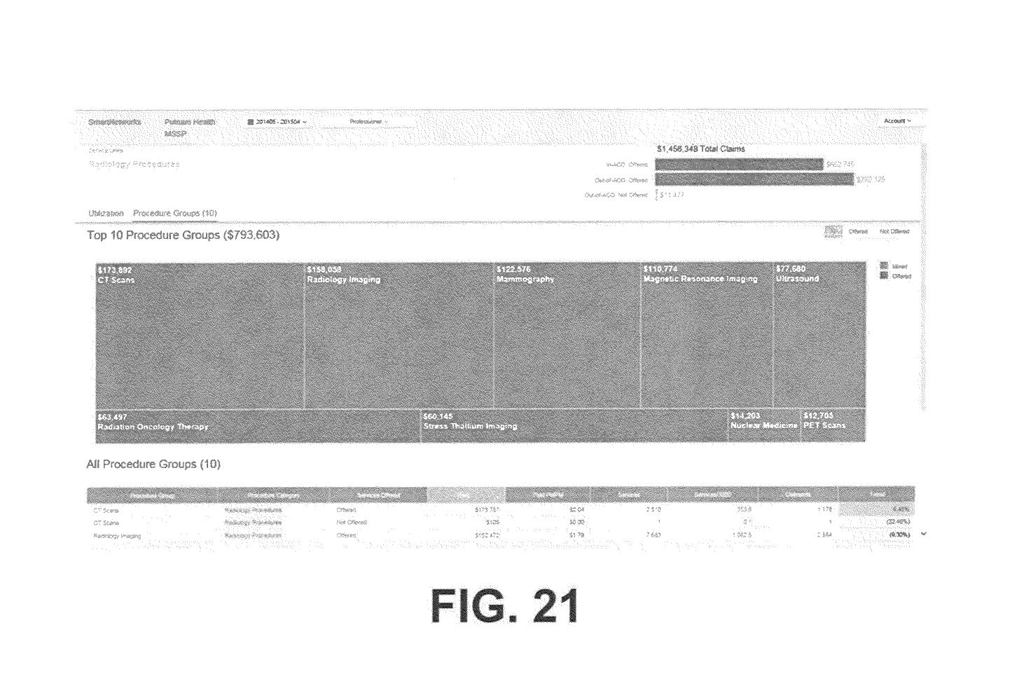

FIG. 21 is an example of a GUI screen providing information regarding procedure groups from a particular professional service line. The GUI screen shown in FIG. 21 may be reached, for example, from the GUI screen shown in FIG. 18A by selecting the rectangular element corresponding to “Radiology Procedures.”

The top portion of FIG. 21 includes out-of-network utilization information for the top 10 procedure groups within the “Radiology Procedures” professional service line, which amounts to $793,603 in this example. Similar to the configuration of FIG. 18A, the dollar amounts and names of the top 10 procedure groups are depicted in rectangular display elements, with the sizes of the rectangles being approximately proportional to the dollar amounts. Similar to the configuration of FIG. 18B, the bottom portion of FIG. 21 includes specific information regarding all the procedure groups in a tabular format including columns for name of procedure group, name of procedure category, distinguishing between offered/not offered information, payment amounts, payment amounts PMPM, number of services, services/1000, number of claimants, and trend information.

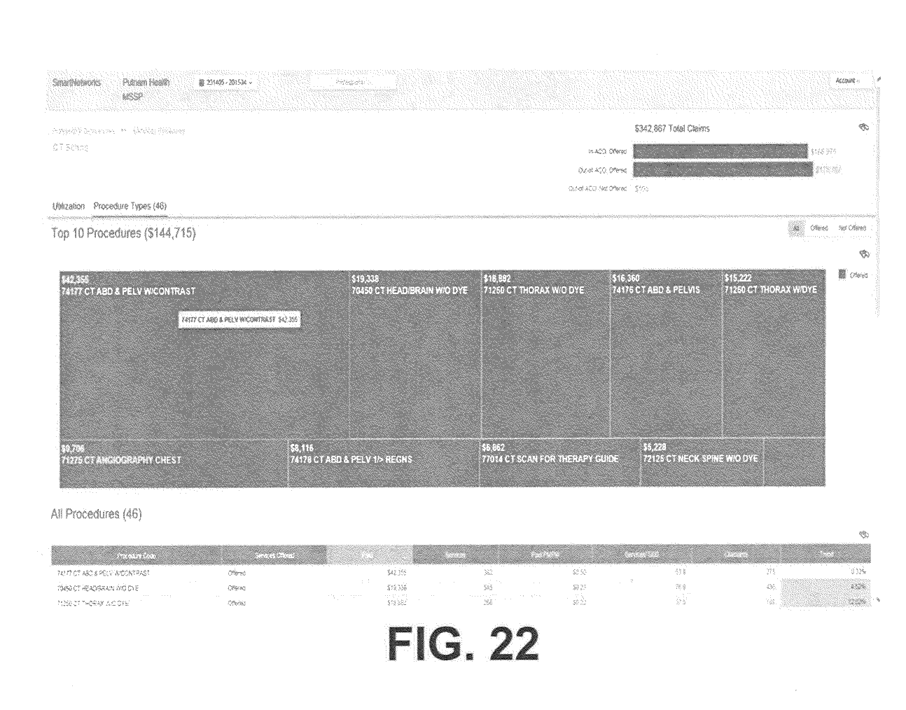

FIG. 22 is an example of a GUI screen providing information regarding procedures from a particular procedure group. The GUI screen shown in FIG. 22 may be reached, for example, from the GUI screen shown in FIG. 21 by selecting the rectangular element corresponding to “CT Scans.”

The top portion of FIG. 22 includes out-of-network utilization information for the top 10 procedures within the “CT Scans” procedure group, which amounts to $144,715 in this example. Similar to the configuration of FIGS. 18A and 21, the dollar amounts and names of the top 10 procedures are depicted in rectangular display elements, with the sizes of the rectangles being approximately proportional to the dollar amounts. A pop-up element providing information regarding the rectangular element may also appear when the user selects a particular rectangular element, for example, by hovering over it with a mouse or single-clicking or single-tapping on the element (e.g., this may be particularly useful where the size of the rectangle is too small to include all of the corresponding information). Similar to the configuration of FIGS. 18B and 21, the bottom portion of FIG. 22 includes specific information regarding all 46 of the procedures in a tabular format including columns for procedure code, distinguishing between offered/not offered information, payment amounts, payment amounts PMPM, number of services, services/1000, number of claimants, and trend information.

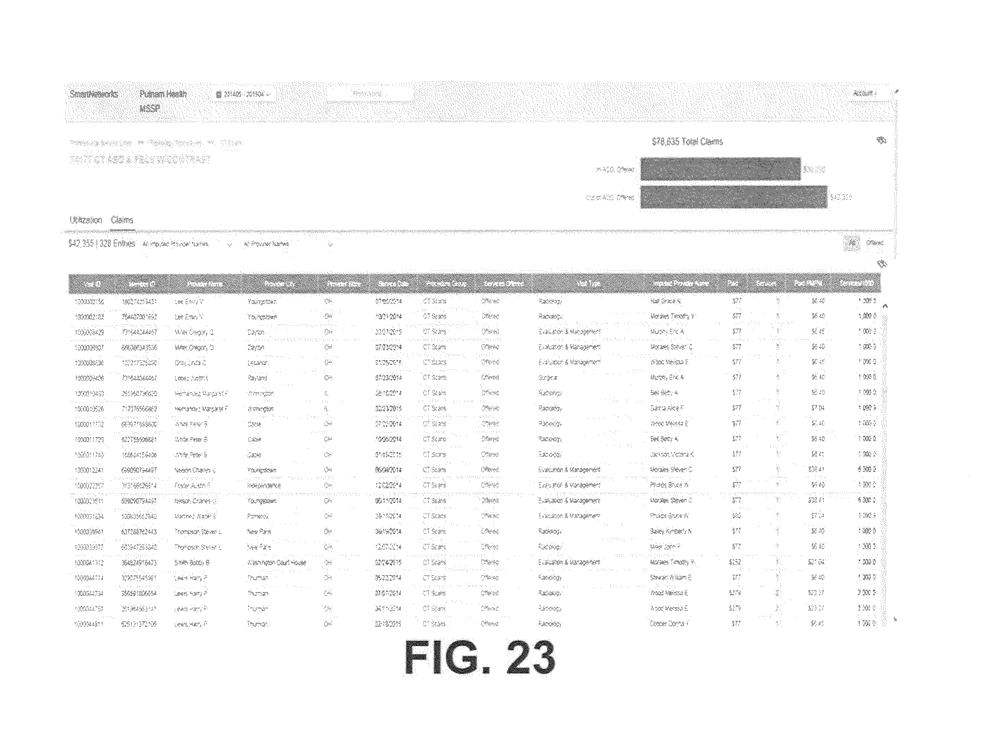

FIG. 23 is an example of a GUI screen providing information regarding claims for a particular procedure. The GUI screen shown in FIG. 23 may be reached, for example, from the GUI screen shown in FIG. 22 by selecting the rectangular element corresponding to “74177 CT ABD & PELV W/CONTRAST” (which is an exemplary procedure code and abbreviated name corresponding to a “computed tomography, abdomen and pelvis; with contrast material” procedure).

FIG. 23 provides detailed information regarding specific claims corresponding to the “74177 CT ABD & PELV W/CONTRAST” procedure, which includes 328 claims amounting to $42,355 in this example. The detailed information is provided in the form of a table including columns for Visit identification (ID), member ID, provider name, provider city, provider state, service date, procedure group, distinguishing between offered/not otffered information, visit type, imputed provider name, payment amount, number of services, payments PMPM and services/1000. FIG. 23 further includes filters for limiting the information displayed in the table based on the imputed provider name or based on the provider name.

As shown in FIGS. 18A-23, the first status bar may be different depending on which GUI screen is currently active. For example, in FIG. 18A, the first status bar includes interactive elements corresponding to “Utilization,” “Professional Service Lines (22),” and “Attributed Practices (19),” while in FIG. 21, the first status bar only includes “Utilization” and “Procedure Groups (10).” Thus, while the user is looking at detailed information corresponding to the “Radiology Procedures” professional service line (as shown in FIG. 21), the user's navigation options will be different from when the user is looking at higher-level information regarding multiple professional service lines (as shown in FIG. 18A).

In certain embodiments, switching to “Utilization” on the first status tab while in a detailed view corresponding to the GUI screens of FIGS. 21-23 allows the user to look at utilization information via plots similar to those shown in FIGS. 12-17, with the information displayed in the plots being limited to a narrower data set (e.g., only data from the “Radiology Procedures” professional service line, only data from the “CT Scans” procedure group, or only data from the “74177 CT ABD & PELV W/CONTRAST” procedure).

FIGS. 24A-24B are examples of GUI screens providing information regarding out-of-network utilization corresponding to attributed practices. The GUI screen shown in FIGS. 24A-24B may be reached from the GUI screens shown in FIGS. 12-17, for example, by receiving a user input selecting the “Attributed Practices (19)” element from the first status bar. FIG. 24A shows a relatively higher portion of the GUI, and, after scrolling down using the scroll bar on the right hand side, the user may reach the information depicted in FIG. 24B.

FIG. 24A shows out-of-network utilization information for the 10 attributed practices with the most out-of-network utilization associated therewith (i.e., patients of these practices of the ACO have paid the most on out-of-network claims), amounting to $35,668,183 in this example. Similar to the configuration of FIG. 18A, the dollar amounts and names of the top 10 attributed practices are depicted in rectangular display elements, with the sizes of the rectangles being approximately proportional to the dollar amounts.

FIG. 24B is similar to the configuration of FIG. 18B in that FIG. 24B includes specific information regarding all 19 attributed practices in a tabular format including columns for imputed provider practice, imputed provider name, distinguishing between offered/not offered information, payment amount, number of services, payments PMPM, services/1000, number of claimants, and trend information.

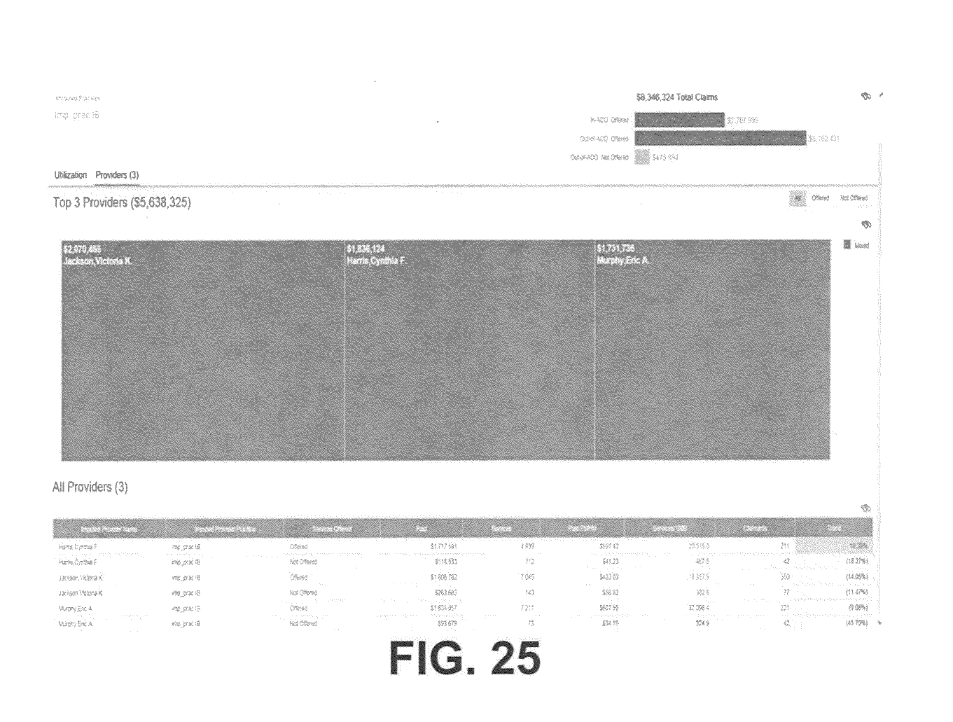

FIG. 25 is an example of a GUI screen providing information regarding providers (e.g., doctors) associated with a particular attributed practice. The GUI screen shown in FIG. 25 may be reached, for example, from the GUI screen shown in FIG. 24A by selecting the rectangular element corresponding to “imp_prac IB” (which is an exemplary dummy value for the name of an attributed practice).

The top portion of FIG. 25 includes out-of-network utilization information for the 3 providers of imp_prac IB, which amounts to $5,638,325 in this example. Similar to the configuration of FIG. 18A, the dollar amounts and names of the providers are depicted in rectangular display elements, with the sizes of the rectangles being approximately proportional to the dollar amounts. It will be appreciated that if there were 10 or more providers of imp_prac IB, the top portion of FIG. 25 may instead provide the out-of-network utilization information for the top 10 providers. It will further be appreciated that in various exemplary embodiments, a different cutoff could be used for FIG. 25 and the other figures as well (e.g., top 5, top 20, etc.).

Similar to the configuration of FIG. 18B, the bottom portion of FIG. 25 includes specific information regarding the providers in a tabular format including columns for imputed provider name, imputed provider practice, distinguishing between offered/not offered information, payment amount, number of services, payments PMPM, services/1000, number of claimants, and trend information.

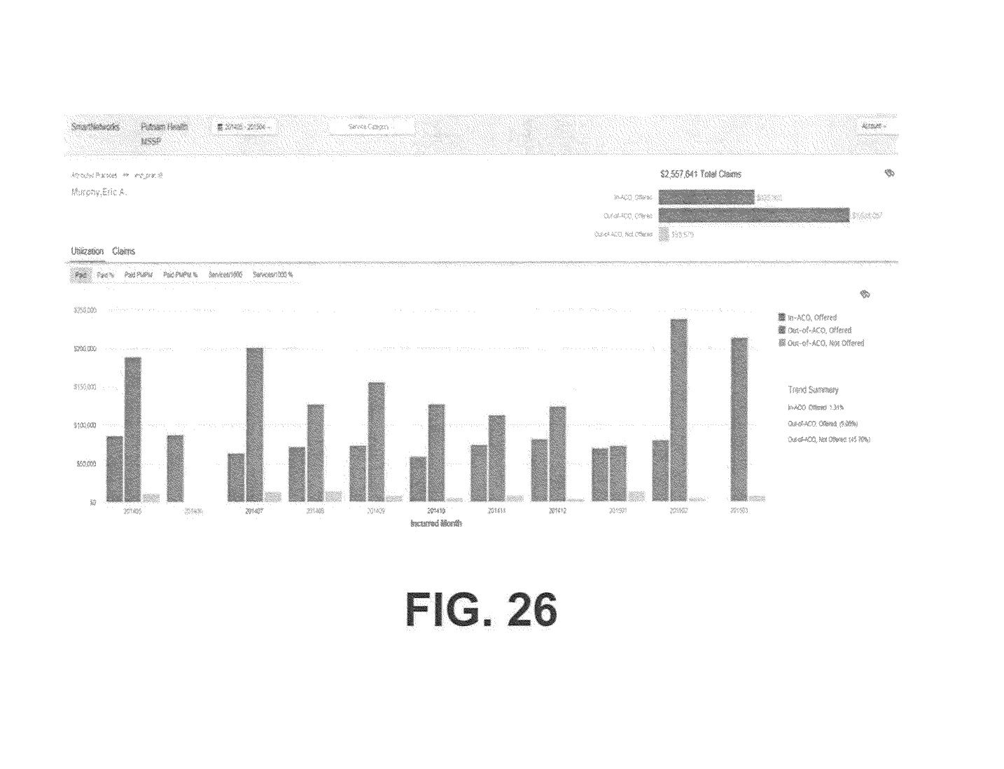

FIG. 26 is an example of a GUI screen providing information regarding out-of-network utilization associated with a particular provider. The GUI screen shown in FIG. 26 may be reached, for example, from the GUI screen shown in FIG. 25 by selecting the rectangular element corresponding to “Murphy, Eric A.” FIG. 26 illustrates utilization information in a plot similar to the plot shown in FIG. 12, with the information displayed in the plot being limited to a narrower data set corresponding only to in-network, out-of-network (offered), and out-of-network (not offered) utilization for patients of “Murphy, Eric A.”

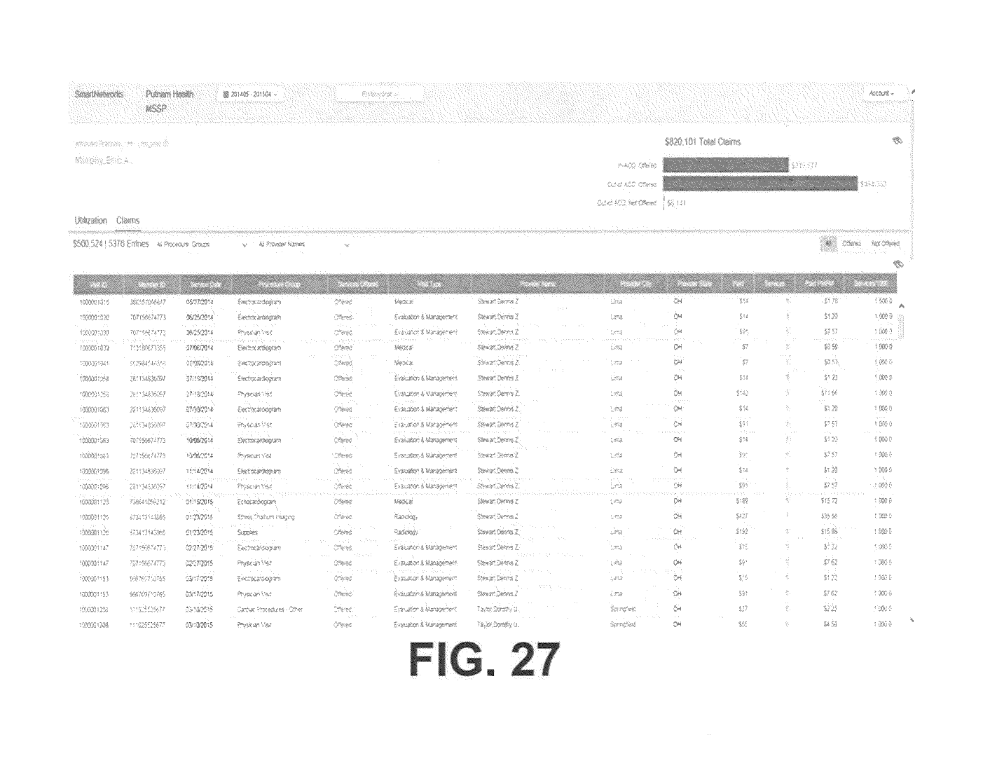

FIG. 27 is an example of a GUI screen providing information regarding claims associated with a particular provider. The GUI screen shown in FIG. 27 may be reached, for example, from the GUI screen shown in FIG. 26 by selecting the interactive element from the first status bar corresponding to “Claims.” FIG. 27 provides detailed information regarding specific out-of-network claims made by patients of “Murphy, Eric A.,” which includes 5376 claims amounting to $500,524 in this example. The detailed information is provided in the form of a table including columns for Visit ID, member ID, service date, procedure group, distinguishing between offered/not offered information, visit type, provider name, provider city, provider state, payment amount, number of services, payments PMPM and services/1000.

It will be appreciated that the screens depicted in FIGS. 12-27 are merely examples, and that the information capable of being reported and the manners in which the information may be reported by various embodiments of the invention are not limited to the exemplary screens depicted in FIGS. 12-27.

In an exemplary embodiment, the reporting functions discussed above are provided by a device for reporting patient out-of-network utilization, which is in communication with an out-of-network utilization analysis system as discussed above. The device may include: a display, configured to display a plurality of graphical user interface (GUI) views relating to patient out-of-network utilization; a user input interface, configured to receive input from a user based on user interaction with the displayed GUI views; a non-transitory computer-readable medium having processor-executable instructions stored thereon; and a processor, configured, based on execution of the processor-executable instructions, to receive patient healthcare utilization information from an out-of-network utilization analysis system and facilitate navigation through the plurality of GUI views on the display based on input received through the user input interface.

As depicted in the exemplary figures, the plurality of GUI views include a first plurality of views graphically illustrating out-of-network utilization relating to claim type and a second plurality of GUI views graphically illustrating out-of-network utilization relating to attribution. The plurality of GUI views may further include a third plurality of GUI views graphically illustrating total utilization, including in-network and out-of-network utilization.

The third plurality of GUI views graphically illustrating total utilization may further include individual GUI views for each of the following: payment amounts, payment percentages, payments per member per month (PMPM), payments PMPM percentages, services/1000, and service/1000 percentages.

Also depicted in the exemplary figures, each of the plurality of GUI views may include an indication of a reporting period to which respective GUI views correspond, with the indication of the reporting period being an interactive element configured to receive user input to change a displayed reporting period to another reporting period. Each of the plurality of GUI views may also include an interactive element configured to receive user input to select a category of claims information for reporting. Each of the plurality of GUI views may further include information regarding the application, regarding the organization to which the reported claims information pertains, and an interactive account management element as well.

The first plurality of GUI views, graphically illustrating out-of-network utilization relating to claim type, may include different GUI view levels associated with service lines, procedure groups of service lines, and procedures of procedure groups. A further GUI view level may also be provided with respect to utilization and claims information for particular procedures.

The second plurality of GUI views, graphically illustrating out-of-network utilization relating to attribution, may include different GUI levels associated with attributed practices and attributed providers of attributed practices. A further GUI view level may also be provided with respect to utilization and claims information for particular attributed providers.

Further, when viewing information relating to out-of-network utilization information at particular GUI view levels, interactive elements may be provided to allow the user to switch between specific views providing out-of-network utilization information pertaining to: (1) both offered and non-offered services; (2) offered services; and (3) non-offered services.

In another exemplary embodiment, a non-transitory, computer-readable medium is provided with processor-executable instructions stored thereon for reporting patient out-of-network utilization. The processor-executable instructions, when executed, facilitate performance of the following: receiving patient healthcare utilization information; generating an out-of-utilization report based on the received patient healthcare utilization information, wherein the out-of-utilization report includes a plurality of graphical user interface (GUI) views relating to patient out-of-network utilization; and displaying, via a reporting application, the plurality of GUI views relating to patient out-of-network utilization on a display.

In one example, as depicted in the foregoing figures, the plurality of GUI views includes GUI views relating to claim type, including different GUI view levels graphically illustrating out-of-network utilization information corresponding to service lines, out-of-network utilization information corresponding to procedure groups of service lines, and out-of-network utilization information corresponding to procedures of procedure groups.

In another example, as also depicted in the foregoing figures, the plurality of GUI views include GUI views relating to attribution, including different GUI view levels graphically illustrating out-of-network utilization information corresponding to attributed practices and out-of-network utilization information corresponding to attributed providers of attributed practices.

In a further exemplary embodiment, the information utilized and displayed in the interactive GUIs discussed above may be provided to another network computing system via an interface such as an application programming interface (API). This other system may provide a framework for building customized GUIs, which allows the user to manipulate the way in which the data relating to claims information and out-of-network utilization is compiled and organized into the interactive GUI for reporting purposes. This provides the user with additional flexibility in configuring the manner in which the out-of-network utilization information is reported, which may allow the user to configure the output to better suit the user's preferences. In the example shown in FIGS. 12-27, there are small binocular icons dispersed throughout the GUI that allow a “power user” to access a framework for customizing the GUI to further modify the content and configuration of the reporting GUI.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A device for reporting patient out-of-network utilization, comprising:
a non-transitory computer-readable medium having processor-executable instructions stored thereon;
a processor, configured, based on execution of the processor-executable instructions, to receive patient healthcare utilization information from an out-of-network utilization analysis system and to facilitate presentation of a graphical user interface (GUI) for reporting the patient out-of-network utilization information to a user;
a display, configured to present the GUI for reporting the patient out-of-network utilization to the user, wherein presenting the GUI to the user includes:
displaying, in a first portion of the GUI, a plurality of adjacent rectangular display elements, wherein a size associated with each rectangular display element corresponds to a magnitude of services represented by the respective rectangular display element;
displaying, in a second portion of the GUI proximate to the first portion of the GUI, interactive elements for modifying the first portion of the GUI, wherein the interactive elements for modifying the first portion of the GUI include a first interactive element providing an option to display a plurality of adjacent rectangular display elements corresponding to out-of-network utilization for services offered in-network in the first portion of the GUI, and a second interactive element providing an option to display a plurality of adjacent rectangular display elements corresponding to out-of-network utilization for services not offered in-network in the first portion of the GUI; and
displaying, in a third portion of the GUI, a plurality of graph display elements, wherein a size associated with each graph display element corresponds to a magnitude of services represented by the respective rectangular display element, wherein the plurality of graph display elements include a first graph element corresponding to in-network utilization for services, a second graph element corresponding to out-of-network utilization for services offered in-network, and a third graph element corresponding to out-of-network utilization for services not offered in-network;
wherein the processor is configured to automatically receive updated patient healthcare utilization information from the out-of-network utilization analysis system in an ongoing manner, and is further configured to automatically update the presentation of the GUI based on the updated patient healthcare utilization information in an ongoing manner.

2. The device according to claim 1, wherein the size associated with each rectangular display element and each graph display element corresponds to an amount and/or value of services.

3. The device according to claim 1, wherein each rectangular display element corresponds to a service line, a procedure group, a procedure, an attributed practice, or a provider.

4. The device according to claim 1, wherein the plurality of graph display elements are arranged in the form of a bar graph.

5. The device according to claim 1, wherein the processor is configured to utilize the plurality of graph display elements in the third portion of the GUI for a plurality of different GUIs.

6. The device according to claim 1, wherein presenting the GUI to the user includes:
displaying, in a fourth portion of the GUI, a table including a plurality of entries corresponding to each rectangular display element.

7. The device according to claim 1, wherein the interactive elements for modifying the first portion of the GUI further include a third interactive element providing an option to display a plurality of adjacent rectangular display elements in a mixed format, wherein in the mixed format, each rectangular display element is displayed as offered, non-offered, or mixed based on respective information corresponding to the rectangular display element.

8. The device according to claim 6, wherein different rectangular display elements displayed as offered, non-offered, and mixed are visually distinct from one another, and wherein presenting the GUI to the user includes:
displaying, in a fifth portion of the GUI, a legend for distinguishing between rectangular display elements displayed as offered, non-offered, and mixed.

9. The device according to claim 1, wherein the processor is further configured, based on execution of the processor-executable instructions, to generate the GUI based on the received patient healthcare utilization information.

10. The device according to claim 1, wherein the GUI is part of the received healthcare utilization information.

11. The device according to claim 1, wherein presenting the GUI to the user includes:
displaying, in a sixth portion of the GUI, an interactive element for adjusting a reporting period.

12. The device according to claim 1, wherein presenting the GUI to the user includes:
displaying, in a seventh portion of the GUI, an interactive element for adjusting a category of services for reporting.

13. A non-transitory, computer-readable medium having processor-executable instructions stored thereon for reporting patient out-of-network utilization, the processor-executable instructions, when executed, facilitating performance of the following:
receiving patient healthcare utilization information;
generating an out-of-utilization report based on the received patient healthcare utilization information, wherein the out-of-utilization report includes a graphical user interface (GUI) relating to patient out-of-network utilization;
displaying, via a reporting application, the GUI relating to patient out-of-network utilization on a display, wherein displaying the GUI includes:
displaying, in a first portion of the GUI, a plurality of adjacent rectangular display elements, wherein a size associated with each rectangular display element corresponds to a magnitude of services represented by the respective rectangular display element; and
displaying, in a second portion of the GUI proximate to the first portion of the GUI, interactive elements for modifying the first portion of the GUI, wherein the interactive elements for modifying the first portion of the GUI include a first interactive element providing an option to display a plurality of adjacent rectangular display elements corresponding to out-of-network utilization for services offered in-network in the first portion of the GUI, and a second interactive element providing an option to display a plurality of adjacent rectangular display elements corresponding to out-of-network utilization for services not offered in-network in the first portion of the GUI;
receiving updated patient healthcare utilization information;
updating the out-of-utilization report based on the updated patient healthcare utilization information, wherein the updated out-of-utilization report includes an updated GUI; and
displaying, via the reporting application, the updated GUI.

14. The non-transitory, computer-readable medium according to claim 13, wherein the interactive elements for modifying the first portion of the GUI further include a third interactive element providing an option to display a plurality of adjacent rectangular display elements in a mixed format, wherein in the mixed format, each rectangular display element is displayed as offered, non-offered, or mixed based on respective information corresponding to the rectangular display element.

15. The non-transitory, computer-readable medium according to claim 13, wherein the size associated with each rectangular display element corresponds to an amount and/or value of services.

16. The non-transitory, computer-readable medium according to claim 13, wherein each rectangular display element corresponds to a service line, a procedure group, a procedure, an attributed practice, or a provider.

17. A non-transitory, computer-readable medium having processor-executable instructions stored thereon for reporting patient out-of-network utilization, the processor-executable instructions, when executed, facilitating performance of the following:
receiving patient healthcare utilization information;
generating an out-of-utilization report based on the received patient healthcare utilization information, wherein the out-of-utilization report includes a graphical user interface (GUI) relating to patient out-of-network utilization;
displaying, via a reporting application, the GUI relating to patient out-of-network utilization on a display, wherein displaying the GUI includes:
displaying, in a first portion of the GUI, a plurality of adjacent rectangular display elements, wherein a size associated with each rectangular display element corresponds to a magnitude of services represented by the respective rectangular display element; and
displaying, in another portion of the GUI, a plurality of graph display elements, wherein a size associated with each graph display element corresponds to a magnitude of services represented by the respective rectangular display element, wherein the plurality of graph display elements include a first graph element corresponding to in-network utilization for services, a second graph element corresponding to out-of-network utilization for services offered in-network, and a third graph element corresponding to out-of-network utilization for services not offered in-network;
receiving updated patient healthcare utilization information;
updating the out-of-utilization report based on the updated patient healthcare utilization information, wherein the updated out-of-utilization report includes an updated GUI; and
displaying, via the reporting application, the updated GUI.

18. The non-transitory, computer-readable medium according to claim 17, wherein the plurality of graph display elements in the third portion of the GUI for a plurality remains displayed after switching to a different GUI of the report.

19. The non-transitory, computer-readable medium according to claim 17, wherein the size associated with each rectangular display element and each graph display element corresponds to an amount and/or value of services.

20. The non-transitory, computer-readable medium according to claim 17, wherein each rectangular display element corresponds to a service line, a procedure group, a procedure, an attributed practice, or a provider.
